(19) United States
(12) Patent Application Publication
(10) Pub. No.: US 2026/0313126 A1
(43) Pub. Date: Oct. 8, 2026

(54) TRANSFORM BASED IMAGE CODING METHOD AND APPARATUS THEREFOR

(71) Applicant: LX SEMICON CO., LTD., Daejeon (KR)

(72) Inventors: Jin Wook LEE, Daejeon (KR); Young Jun KIM, Daejeon (KR)

(73) Assignee: LX SEMICON CO., LTD., Daejeon (KR)

(21) Appl. No.: 19/638,613

(22) Filed: Apr. 3, 2026

(30) Foreign Application Priority Data
Apr. 4, 2025 (KR) 10-2025-0044245

(51) Int. Cl. H04N 19/132; H04N 19/176; H04N 19/18; H04N 19/70

(52) U.S. Cl. CPC H04N 19/132; H04N 19/176; H04N 19/18; H04N 19/70

(57) ABSTRACT

An image decoding method according to an embodiment of the present disclosure includes receiving image information including residual information for a current block, decoding syntax elements included in the residual information, decoding transform coefficients for sub-blocks of the current block based on the decoded syntax elements, and deriving residual samples for the sub-blocks based on the transform coefficients, wherein whether parity hiding is applied to the current block is determined, and wherein a parity bit for a first transform coefficient among the transform coefficients is derived based on that the parity hiding is applied to the current block.

### CROSS REFERENCE TO RELATED APPLICATION

The present application claims priority to Korean Patent Application No. 10-2025-0044245 filed on Apr. 4, 2025, the entire contents of which is incorporated herein for all purposes by this reference.

### BACKGROUND OF THE DISCLOSURE

### Field of the Disclosure

The disclosure relates to an image/video coding method and an image/video coding apparatus.

### Related Art

With an increasing use of multimedia data, the need for efficient video compression technology is rising. Video compression is essential for effectively transmitting high-quality image data within limited network bandwidth. To this end, various video codec technologies have been developed.

Video codec technologies include MPEG-2, H.264/AVC, H.265/HEVC, H.266/VVC, and AOMedia video 1 (AV1), which are expected to be widely utilized in diverse applications, such as Internet-based video streaming, video calls, virtual reality (VR), and augmented reality (AR).

As images/video reach high resolution and high quality, the data size of images/video expands, resulting in a relative increase in the amount of information or bits transmitted. Therefore, when transmitting image data using conventional media, such as wired and wireless broadband lines, or storing image/video data using existing storage media, costs for transmission and storage rise. To provide further improved compression efficiency image quality, there is a growing need for successor codec technologies, such as H.267 and AV2. In other words, high-efficiency image/video compression technology is required to effectively compress, transmit, store, and play high-resolution and high-quality image/video information.

### SUMMARY

According to an embodiment of the disclosure, there are provided a method and an apparatus for enhancing video/image coding efficiency.

According to an embodiment of the disclosure, there are provided a method and an apparatus for providing a next-generation high-quality video service.

According to an embodiment of the disclosure, there are provided a method and an apparatus for providing enhanced performance in a real-time streaming environment.

According to an embodiment of the disclosure, there are provided a method and an apparatus for intra prediction-based video/image coding.

According to an embodiment of the disclosure, there are provided a method and an apparatus for transform-based video/image coding.

According to an embodiment of the disclosure, there is provided an image decoding method performed by a decoding apparatus. The method comprises receiving image information including residual information for a current block, decoding syntax elements included in the residual information, decoding transform coefficients for sub-blocks of the current block based on the decoded syntax elements, and deriving residual samples for the sub-blocks based on the transform coefficients, wherein whether parity hiding is applied to the current block is determined, and wherein a parity bit for a first transform coefficient among the transform coefficients is derived based on that the parity hiding is applied to the current block.

According to an embodiment of the disclosure, there is provided an image encoding method performed by an encoding apparatus. The method comprises deriving residual samples for a current block, deriving transform coefficients for sub-blocks of the current block based on the residual samples, encoding the transform coefficients, and encoding image information including the encoded transform coefficients, wherein whether parity hiding is applied to the current block is determined, and wherein a parity bit is not signaled for a first transform coefficient among the transform coefficients based on that the parity hiding is applied to the current block.

According to an embodiment of the disclosure, there is provided a decoding apparatus for image decoding. The decoding apparatus comprises a memory and at least one processor connected to the memory, wherein the at least one processor is configured to receive image information including residual information for a current block through a bitstream, decode syntax elements included in the residual information, decode transform coefficients for sub-blocks of the current block based on the decoded syntax elements, and derive residual samples for the sub-blocks based on the transform coefficients, wherein whether parity hiding is applied to the current block is determined, and wherein a parity bit for a first transform coefficient among the transform coefficients is derived based on that the parity hiding is applied to the current block.

According to an embodiment of the disclosure, there is provided an encoding apparatus for image encoding. The encoding apparatus comprises a memory and at least one processor connected to the memory, wherein the at least one processor is configured to derive residual samples for a current block, derive transform coefficients for sub-blocks of the current block based on the residual samples, encode the transform coefficients, and encode image information including the encoded transform coefficients, wherein whether parity hiding is applied to the current block is determined, and wherein a parity bit is not signaled for a first transform coefficient among the transform coefficients based on that the parity hiding is applied to the current block.

According to an embodiment of the disclosure, there is provided a method for storing or transmitting video/video data including a bitstream generated by a video/image encoding method according to at least one of embodiments of the disclosure.

According to an embodiment of the disclosure, there is provided an apparatus for storing or transmitting video/video data including a bitstream generated by a video/image encoding method according to at least one of embodiments of the disclosure.

According to an embodiment of the disclosure, there is provided a computer-readable storage medium that stores a program for performing a method according to at least one of the embodiments of the disclosure.

According to an embodiment of the disclosure, there is provided a computer-readable digital storage medium that stores encoded video/image information generated by a video/image encoding method according to at least one of embodiments of the disclosure.

According to an embodiment of the disclosure, there is provided a computer-readable digital storage medium that stores encoded information or encoded video/image information that causes a decoding apparatus to perform a video/image decoding method according to at least one of the embodiments of the disclosure.

According to an embodiment of the disclosure, overall video/image compression efficiency may be enhanced.

According to an embodiment of the disclosure, prediction performance for a current block may be enhanced.

According to an embodiment of the disclosure, signaling efficiency of transform-related information may be enhanced.

According to an embodiment of the disclosure, an amount of information to be signaled may be reduced by hiding parity for a specific transform coefficient.

According to an embodiment of the disclosure, coding efficiency may be enhanced and image compression performance may be enhanced by adaptively deriving a parity bit of a transform coefficient.

### BRIEF DESCRIPTION OF THE DRAWINGS

FIG. 1 schematically illustrates an example of a video/image coding system to which embodiments of the disclosure are applicable.

FIG. 2 is a diagram schematically illustrating a configuration of a video/image encoding apparatus to which embodiments of the disclosure are applicable.

FIG. 3 is a diagram schematically illustrating a configuration of a video/image decoding apparatus to which embodiments of the disclosure are applicable.

FIG. 4 illustrates examples of a residual process-based video/image encoding method.

FIG. 5 illustrates examples of a residual process-based video/image decoding method.

FIG. 6 exemplarily illustrates a multiple transform technique according to the present disclosure.

FIG. 7 is a diagram illustrating an example of LFNST.

FIGS. 8 and 9 illustrate examples of transform coefficients within a block.

FIG. 10 schematically illustrates a video/image encoding method according to embodiment(s) of the present disclosure.

FIG. 11 schematically illustrates a video/image decoding method according to embodiment(s) of the present disclosure.

### DESCRIPTION OF EXEMPLARY EMBODIMENTS

As the disclosure may have various changes and various embodiments, specific embodiments are illustrated in the drawings and will be described in detail. However, it should be understood that there is no intent to limit embodiments of the disclosure to the specific embodiments. The terminology used herein is for the purpose of describing particular embodiments only and is not intended to limit the technical spirit of the disclosure. As used in the disclosure, singular forms are intended to include plural forms unless the context clearly indicates otherwise. As used herein, the term “and/or” includes any one and all combinations of two or more of the associated listed items. As used herein, the term “include,” “include,” and “have” specify the presence of stated features, numbers, operations, elements, components, and/or combinations thereof, but do not preclude the presence or addition of one or more other features, numbers, operations, elements, components, and/or combinations thereof. In the disclosure, the use of the term “may” in connection with an example or embodiment (e.g., regarding what an example or embodiment may include or implement) signifies that there is at least one example or embodiment in which such a feature is included or implemented, but all examples are not limited thereto and the corresponding feature or configuration may be omitted.

Each component of the drawings described in the disclosure is shown independently for the convenience of explaining distinct characteristic functions, which does not imply that each component is implemented as separate hardware or separate software. For example, two or more of these components may be combined to form a single component, or a single component may be divided into a plurality of components. Embodiments in which components are integrated and/or separated are also included within the scope of the disclosure without departing from the essence of the disclosure.

In the disclosure, “A or B” may mean “only A,” “only B,” or “both A and B.” In other words, “A or B” may be interpreted as “A and/or B” in the disclosure. For example, “A, B, or C” in the disclosure may mean “only A,” “only B,” “only C,” or “any and all combinations of A, B and C.”

A slash (/) or a comma as used herein may mean “and/or.” For example, “A/B” may mean “A and/or B.” Accordingly, “A/B” may mean “only A,” “only B,” or “both A and B.” For example, “A, B, C” may mean “A, B, or C.”

In the disclosure, “at least one of A and B” may mean “only A,” “only B,” or “both A and B.” Further, the expression “at least one of A or B” or “at least one of A and/or B” may be interpreted identically to “at least one of A and B.”

In the disclosure, “at least one of A, B and C” may mean “only A,” “only B,” “only C,” or “any and all combinations of A, B and C.” In addition, “at least one of A, B or C” or “at least one of A, B and/or C” may mean “at least one of A, B and C.”

Parentheses used in the disclosure may mean “for example.” Specifically, when indicated as “prediction (intra prediction),” “intra prediction” may be proposed as an example of “prediction.” In other words, “prediction” in the disclosure is not limited to “intra prediction,” and “intra prediction” may be proposed as an example of “prediction.” Furthermore, even when indicated as “prediction (i.e., intra prediction),” “intra prediction” may be proposed as an example of “prediction.”

In the disclosure, technical features individually explained within a single drawing may be implemented independently, or may be implemented simultaneously.

The disclosure relates to video/image coding. For example, a method/embodiment described in the disclosure may be applied to a method disclosed in an AOMedia Video 2 (AV2) standard. In addition, the method/embodiment disclosed herein may be applied to a method disclosed in an enhanced compression model, an H.267 standard, or a next-generation video/image coding standard (e.g., H.268 and H.269).

In the disclosure, coding may include encoding and/or decoding. In the disclosure, image coding may be used interchangeable with video coding.

In the disclosure, a video may refer to a set of a series of images over time. A frame generally refers to a unit representing a single image at a specific time, and a slice/tile refers to a unit forming a portion of a frame in coding. A slice/tile may include one or more superblock. A single frame may include one or more slices/tiles. A tile may represent a rectangular area of superblocks within a specific tile row and a specific tile column in a frame. A single frame may be divided into two or more subframes.

A pixel or a pel may mean a smallest unit forming one frame (or image). “Sample” may be used as a term corresponding to a pixel. A sample may generally represent a pixel or a pixel value, and may represent only a pixel/pixel value of a luma component or only a pixel/pixel value of a chroma component.

A unit may represent a basic unit of image processing. A unit may include at least one of a specific area of a frame and information related to the area. A single unit may include one luma block and two chroma (e.g., Cb and cr) blocks. A unit may be used interchangeably with terms such as a “block” or an “area” in some cases. In general, an M×N block may include a set (or array) of samples (or a sample array) or transform coefficients in M columns and N rows.

Hereinafter, embodiments of the disclosure will be described in detail with reference to the accompanying drawings. In addition, like reference numerals may be used to indicate like elements throughout the drawings, and redundant descriptions of the like elements may be omitted.

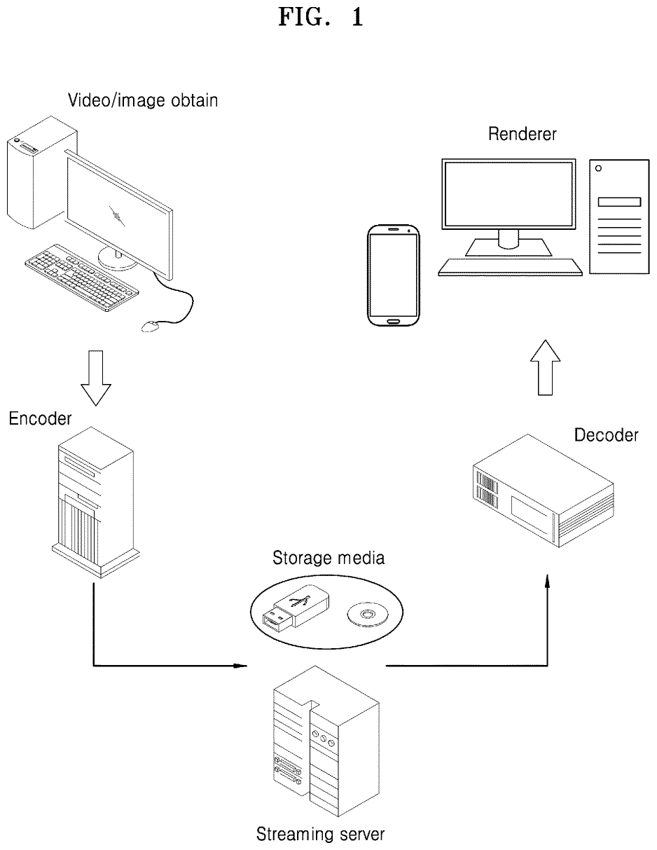

FIG. 1 schematically illustrates an example of a video/image coding system to which embodiments of the disclosure are applicable.

Referring to FIG. 1, the video/image coding system may include a first apparatus (encoding apparatus) and a second apparatus (decoding apparatus). The first apparatus may deliver encoded video/image information or data in a form of a file or streaming to the second apparatus via a digital storage medium or a network.

The video/image coding system may further include a video/image acquisition device and a video/image renderer. The video/image acquisition device may be included in the encoding apparatus, or may be configured as a separate device or an external component. The video/image renderer may be included in the decoding apparatus, or may be configured as a separate device or an external component.

The first apparatus may include a transmitter as an internal component, or as a separate device or an external component.

The second apparatus may include a receiver as an internal component, or as a separate device or an external component.

The encoding apparatus may be referred to as an encoder, and the decoding apparatus may be referred to as a decoder. The transmitter may be included in the encoding apparatus. The receiver may be included in the decoding apparatus. The renderer may include a display, and the display may be configured as a separate device or an external component.

The decoding apparatus and the encoding apparatus to which an embodiment(s) of the disclosure is applied may be included in a multimedia broadcasting transmission/reception device, a mobile communication terminal, a home cinema video device, a digital cinema video device, a surveillance camera, a video conversation device, a real-time communication device such as video communication, a mobile streaming device, a storage medium, a camcorder, a video-on-demand (VoD) service providing device, an over-the-top (OTT) video device, an Internet streaming service providing device, a three-dimensional (3D) video device, a virtual reality (VR) device, an augmented reality (AR) device, a video telephony device, a transportation terminal (e.g., a vehicle terminal (including an autonomous vehicle terminal), an aircraft terminal, and a vessel terminal), and a medical video device, and may be used to process a video signal or a data signal. For example, the over-the-top (OTT) video device may include a game console, a Blu-ray player, an Internet-connected TV, a home theater system, a smartphone, a tablet PC, and a digital video recorder (DVR).

The video/image acquisition device may obtain a video/image source. The video/image acquisition device may obtain a video/image through a process of capturing, synthesizing, or generating a video/image. The video/image acquisition device may include a video/image capture device and/or a video/image generation device. The video/image capture device may include, for example, one or more cameras and a video/image archive including previously captured video/images. The video/image generation device may include, for example, a camcorder, a computer, a tablet PC, and a smartphone, and may (electronically) generate a video/image. For example, a virtual video/image may be generated through a computer, in which case a video/image capture process may be replaced with a process of generating related data. The video/image source may perform a video/image preprocessing process to input an optimized video/image to the encoder.

The encoding apparatus may encode an input video/image. The encoding apparatus may encode an input video/image through an encoding method disclosed herein. The encoding apparatus may perform a series of procedures, such as prediction, transform, and quantization, for compression and coding efficiency. Encoded data (encoded video/image information) may be output in a form of a bitstream.

The transmitter may transmit encoded image/image information or data output in a form of a bitstream to the receiver of the receiving device in a form of a file or streaming through the digital storage medium or the network. The encoded image/image information or data output in the form of the bitstream may be transmitted to the receiver through a streaming server. The digital storage medium may include various storage mediums, such as a USB, an SD, a CD, a DVD, a Blu-ray, an HDD, and an SSD. The transmitter may include an element for generating a media file through a predetermined file format, and may include an element for transmission through a broadcast/communication network. The receiver may receive/extract the bitstream and transmit the received bitstream to the decoding apparatus. In the disclosure, the transmitter may be referred to as a transmitting apparatus, and the receiver may be referred to as a receiving apparatus. As image/video resolution and quality become higher, the raw data size of images/videos is increasing. By obtaining and storing/transmitting a bitstream (or data including the bitstream) generated by an efficient encoding method according to the disclosure, it is possible to increase storage/transmission efficiency and support low-latency/real-time transmission.

The streaming server may temporarily store the bitstream during a process of transmitting or receiving the bitstream. The streaming server transmits multimedia data to a user device, based on a user request via a web server, and the web server serves as an intermediary for informing a user of an available service. When the user requests a desired service from the web server, the web server transmits the request to the streaming server, and the streaming server transmits multimedia data to the user. The content streaming system may include a separate control server, in which case the control server controls a command/response between devices in the content streaming system.

The streaming server may receive content from a media storage and/or the encoding apparatus. For example, when receiving content from the encoding apparatus, the content may be received in real time. In this case, the streaming server may store the bitstream for a certain time to provide a smooth streaming service.

The decoding apparatus may decode the video/image by performing a series of procedures, such as dequantization, inverse transform, and prediction, corresponding to an operation of the encoding apparatus. The decoding apparatus may decode a video/image through a decoding method disclosed herein.

The renderer may render the decoded video/image. The rendered video/image may be displayed on the display.

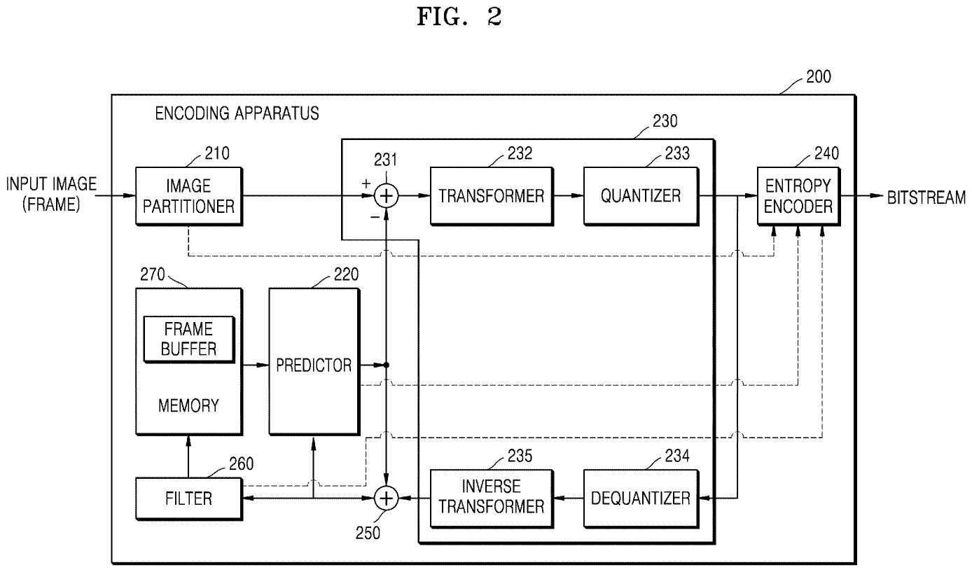

FIG. 2 is a diagram schematically illustrating a configuration of a video/image encoding apparatus to which embodiments of the disclosure are applicable. Hereinafter, an encoding apparatus may include an image encoding apparatus and/or a video encoding apparatus.

Referring to FIG. 2, the encoding apparatus 200 may include an image partitioner 210, a predictor 220, a residual processor 230, and an entropy encoder 240, an adder 250, a filter 260, and a memory 270. The predictor 220 may include an inter predictor and an intra predictor. The residual processor 230 may include a transformer 232, a quantizer 233, a dequantizer 234, and an inverse transformer 235. The residual processor 230 may further include a subtractor 231. The adder 250 may be referred to as a reconstructor or a reconstructed block generator. The image partitioner 210, the predictor 220, the residual processor 230, the entropy encoder 240, the adder 250, and the filter 260 may be configured as at least one hardware component (e.g., an encoder chipset or processor) according to an embodiment. The memory 270 may include a frame buffer, or may be configured as a digital storage medium. The hardware component may further include the memory 270 as an internal/external component.

The image partitioner 210 may partition an input image (or a picture or a frame) input to the encoding apparatus 200 into one or more processing unit. For example, the processing unit may include a superblock or a coding unit (CU). A frame may be partitioned into a plurality tiles. A tile may have a rectangular shape. Uniform or non-uniform tile sizes may be determined on a per-frame basis. In the disclosure, the terms “frame” and “picture” may be used interchangeably. A tile may include an integer number of superblocks. Superblocks within a tile may be coded in raster scan order. A superblock may be partitioned into one or more coding blocks. For example, a superblock may have a size of 128×128 or 64×64 based on a luma component. Alternatively, a superblock may have a size of 256×256 based on the luma component. A superblock may have a dependency only on specific neighboring superblocks. For example, a superblock may have a dependency only on left and/or upper neighboring superblocks.

A superblock may be recursively partitioned. For example, a superblock may be derived as a single coding block, or a superblock may be partitioned into coding blocks, based on a binary tree, a ternary tree, or a quad tree. One coding block may be recursively partitioned into a plurality of coding blocks of a deeper depth, based on a binary tree, a ternary tree, or a quad tree. For example, when a coding block is partitioned into PARTITION_N×N, recursive partitioning may be possible. A coding procedure according to the disclosure may be performed based on a final coding block that is no longer partitioned. In this case, a superblock may be directly used as the final coding block, based on coding efficiency according to video characteristics. Alternatively, a coding block may be recursively partitioned into deeper-depth coding blocks as needed so that a coding block with an optimal size may be used as the final coding block. Here, the coding procedure may include procedures such as prediction, transform, and reconstruction, which will be described later. The processing unit may further include a prediction block (PB) or a transform block (TB). In this case, the prediction block or the transform block may be split or partitioned from the final coding block described above. For example, a single transform block of the same size as the coding block may be derived, or a plurality of transform blocks may be derived from the coding block, based on a quad tree or binary tree. The transform block may be recursively partitioned into deeper-depth transform blocks. The prediction block may be a unit for prediction (or for deriving a prediction mode), and the transform block may be a unit for performing a transform, a unit for deriving a transform coefficient, and/or a unit for deriving a residual signal from a transform coefficient. For example, prediction mode derivation for intra prediction may be performed on a coding block basis or a prediction block basis, and prediction sample derivation through an intra prediction procedure may be performed on a transform block basis. A block to be currently processed according to a coding order may be referred to as a current block.

The term “block” may be used interchangeably with the term “unit” or “area” depending on a case. In general, an M×N block may denote an array of samples or transform coefficients arranged in M rows and N columns. A sample may generally denote a pixel or a pixel value, and may represent only a pixel/pixel value of a luma component or only a pixel/pixel value of a chroma component. A “sample” may be used as a term corresponding to a pixel or pel of a frame (or image).

The encoding apparatus 200 may generate a residual signal (residual signal, residual block, or residual sample array) by subtracting a prediction signal (predicted block or predicted sample array) output from the predictor from an input image signal (original block or original sample array), and the generated residual signal is transmitted to the transformer 232. In this case, as illustrated, a component for subtracting the prediction signal (predicted block or predicted sample array) from the input image signal (original block or original sample array) in the encoder 200 may be referred to as the subtractor 231. The predictor may perform prediction on a processing target block (hereinafter, referred to as a current block), and may generate a predicted block including prediction samples for the current block. The predictor may determine whether intra prediction or inter prediction is applied on a current block or coding block basis. The predictor may generate various pieces of information about prediction, such as prediction mode information, and may transmit the generated information to the entropy encoder 240, as described below in a description of each prediction mode. The information about prediction may be encoded by the entropy encoder 240 and output in a form of a bitstream.

The intra predictor may predict the current block with reference to samples within a current frame. The referenced samples may be located adjacent to (neighboring) the current block, or may be located away from the current block depending on a prediction mode. Intra prediction may be performed on a transform block basis. When a plurality of transform blocks exists in a coding block, intra prediction may be performed sequentially in a raster order of the transform blocks. In this case, a procedure for deriving neighboring reference samples for intra prediction may be performed based on a transform block. A plurality of prediction modes may be considered for intra prediction. The prediction modes may include a plurality of non-directional modes and a plurality of directional modes. A prediction mode used for the current block may be signaled from the encoding apparatus to a decoding apparatus, and the prediction modes may include, for example, a DC intra prediction mode, a plurality of directional intra prediction modes, a plurality of SMOOTH intra prediction modes, and/or a PAETH intra prediction mode. The prediction modes may include an intra block copy (intrabc) mode. Whether the intra block copy mode is applied may be signaled separately. The directional prediction modes may include, for example, eight or more prediction modes depending on a prediction direction, which is, however, only for illustration, and a greater or smaller number of directional prediction modes may be used depending on a configuration. The intra predictor may also determine a prediction mode to be applied to the current block, based on a prediction mode applied to a neighboring block. In the intra block copy mode, similar to an inter prediction mode described below, a reference block is derived based on a vector, and the current frame is used as a reference frame. The vector used to derive the reference block in the intra block copy mode may be referred to as a block vector.

The inter predictor may induce a predicted block for the current block, based on a reference block (reference sample array) specified by a motion vector on a reference picture. Here, to reduce the amount of motion information transmitted in the inter prediction mode, motion information may be predicted on a block, sub-block, or sample basis, based on a correlation in motion information between a neighboring block and the current block. The motion information may include a motion vector and/or a reference frame index. The motion information may further include inter prediction direction (L0 prediction, L1 prediction, and compound prediction) information. In inter prediction, the neighboring block may include a spatial neighboring block existing within a current frame and a temporal neighboring block existing in the reference frame. A reference frame including the reference block and the reference frame including the temporal neighboring block may be the same or different. The temporal neighboring block may be referred to as a co-located reference block or a co-located block (colblock), and the reference frame including the temporal neighboring block may also be referred to as a co-located frame (colframe). For example, the inter predictor may configure a motion information stack, based on neighboring blocks, and may generate information indicating a candidate used to derive the motion vector and/or the reference frame index of the current block. The motion information stack may be referred to as a motion information list. The motion information stack may include a motion vector stack. The motion vector stack may be referred to as RefStackMv. The motion vector stack may include eight or more candidates.

Information about the (maximum) number of candidates of the motion vector stack may be signaled on a frame or sequence basis. For inter prediction, a motion mode may be additionally considered. The motion mode may include a simple mode, an overlapped block motion compensation (OBMC) mode and/or a local warp mode. The OBMC mode may improve prediction performance by using motion information about a neighboring block at a left and/or upper boundary of the current block, and the local warp mode may apply an affine model in addition to translational motion compensation.

A motion vector may be derived based on various prediction modes. For example, in an NEWMV mode, a motion vector of the current block may be indicated based on a motion vector of a reference stack and a motion vector difference. If needed, in the NEWMV mode, the motion vector of the current block may be indicated based on the motion vector difference without the motion vector of the reference stack. Information about the motion vector difference may be generated by the encoding apparatus and signaled to the decoding apparatus. A ZEROMV mode may indicate that a zero vector or a default vector is used as the motion vector of the current block. An REFMV mode may indicate that a motion vector of the motion information stack is used as the motion vector of the current block. However, these designations are only examples, and the motion vector of the current block may be indicated by various other names. For example, a GLOBALMV mode may indicate that global motion information is used for the current block. For example, an NEARSTMV mode may indicate that a first candidate (candidate at index 0) of the motion information stack is used for the current block. For example, an NEARMV mode may indicate that a specific candidate (indicated by refMVidx) of the motion information stack is used for the current block. However, the above mode names are examples, and other names, such as mode 1 and mode 2, may be used if needed.

When compound prediction is applied, inter prediction may be performed using both reference frame lists L0 and L1. In this case, a motion vector for an L0 direction and a motion vector for an L1 direction may be derived. Furthermore, an L0 reference frame for the L0 direction and an L1 reference frame for the L1 direction may be derived. If needed, a first motion vector and a second motion vector may be used instead of an L0 motion vector and an L1 motion vector, respectively. If needed, a first reference frame and a second reference frame may be used instead of the L0 reference frame and the L1 reference frame, respectively.

The predictor 220 may generate a prediction signal, based on various prediction methods. For example, the predictor may apply intra prediction or inter prediction for prediction of one block, and may simultaneously apply intra prediction and inter prediction, which may be referred to as compound inter-intra prediction. In this case, a mode used for the intra prediction may include the DC prediction mode, a vertical prediction mode, a horizontal prediction mode, and the SMOOTH prediction mode. Further, the predictor may be based on the intra block copy mode described above or a palette mode for the prediction of the block. As described above, the intra block copy mode is a type of intra prediction and basically performs prediction within the current frame, but may be performed similarly to inter prediction in that the mode derives a reference block, based on a vector using the current frame as a reference frame. However, since the current frame is used as the reference frame, the term “block vector” may be used for a vector for displacement instead of “motion vector”. That is, the intra block copy mode may utilize at least one of inter prediction techniques described in the disclosure. In this case, a motion vector derived through a neighboring block or the motion information stack may be referenced for deriving a block vector of the current block. For example, when the intra block copy mode is applied, the foregoing NEWMV mode may be used for deriving the block vector of the current block.

The prediction signal generated by the predictor 220 may be used to generate a reconstructed signal or to generate a residual signal. The transformer 232 may generate transform coefficients by applying a transform technique to the residual signal. For example, the transform technique may include at least one of a discrete cosine transform (DCT), a discrete sine transform (DST), a Karhunen-Loeve transform (KLT), a graph-based transform (GBT), or a conditionally non-linear transform (CNT). Further, the transform technique may include, for example, a DCT, asymmetric discrete sine transform (ADST), a flipped ADST (FLIPADST), an identity transform (IDTX), a Walsh-Hadamard transform (WHT), a V_DCT, and an H_DCT. The DCT is one of the most widely used transformation techniques in image compression, primarily transforming image signals into a frequency domain to concentrate energy into low-frequency components. The ADST is similar to the DCT, but is designed to smoothly connect signals at block boundaries. The FLIPADST is a modified version of the ADST that applies a transform in a reversed direction, enabling more efficient signal compression for a specific block pattern. The IDTX is an identity transformation method that maintains a signal without any transformation. The identity transform may be applied to either a vertical transform or a horizontal transform, or both. For example, when a transformation method is specified for only one of the vertical and horizontal transforms, the identity transform may be implicitly applied to the other transform. The WHT is a linear transform similar to a discrete Fourier transform (DFT) or discrete cosine transform (DCT), representing signals or data by transforming the same into a different basis. The WHT may use an orthogonal basis matrix including +1 and −1 instead of using a trigonometric function (sine and cosine). The V_DCT and the H_DCT indicate that the DCT transform is performed in the vertical direction of a block and the DCT transform is performed in the horizontal direction of the block, respectively. For example, for a simple block, the DCT may be used to increase a compression ratio, while the ADST or FLIPADST may be used when smooth transitions are required at boundaries. For a block where a signal remains nearly unchanged, the IDTX may be applied.

The quantizer 233 may quantize the transform coefficients and transmit the same to the entropy encoder 240, and the entropy encoder 240 may encode a quantized signal (information about the quantized transform coefficients) and output the encoded signal as a bitstream. The information about the quantized transform coefficients may be referred to as residual information. The quantizer 233 may rearrange the quantized transform coefficients in a block form into a one-dimensional vector form, based on a coefficient scan order, and may generate the information about the transform coefficients, based on the quantized transform coefficients in the one-dimensional vector form. The entropy encoder 240 may perform various encoding methods, for example, a cumulative distribution function and context-adaptive binary arithmetic coding (CABAC). The CDF is a method of storing cumulative values of a probability distribution, allowing symbols to be represented with fewer bits compared to storing probabilities directly. Within the CDF, symbol probabilities may be adaptively adjusted based on context. The entropy encoder 240 may encode information (e.g., values of syntax elements) necessary for video/image reconstruction other than the quantized transform coefficients together or separately. The encoded information (e.g., encoded video/image information) may be packetized on an open bitstream unit (OBU) basis in a form of a bitstream and be transmitted or stored. The video/image information may further include information commonly applied to a specific range, such as a tile header, a frame header, and a sequence header. In the disclosure, information and/or syntax elements transmitted/signaled from the encoding apparatus to the decoding apparatus may be included in the video/image information. The video/image information may be encoded through the foregoing encoding procedure and included in the bitstream. The bitstream may be transmitted through a network, or may be stored in a digital storage medium. The network may include a broadcasting network and/or a communication network, and the digital storage medium may include various storage media, such as a USB, an SD, a CD, a DVD, a Blu-ray, an HDD, and an SSD. A transmitter (not shown) and/or a storage (not shown) for transmitting and/or storing a signal output from the entropy encoder 240 may be configured as internal/external elements of the encoding apparatus 200, or the transmitter may be included in the entropy encoder 240.

The quantized transform coefficients output from the quantizer 233 may be used to generate a prediction signal. For example, the residual signal (residual block or residual samples) may be reconstructed by applying dequantization and inverse transform to the quantized transform coefficients through the dequantizer 234 and the inverse transformer 235. The adder 250 may add the reconstructed residual signal to the prediction signal output from the predictor to generate a reconstructed signal (reconstructed frame, reconstructed block, or reconstructed sample array). When there is no residual for the processing target block, such as when a skip mode is applied, the predicted block may be used as a reconstructed block. The adder 250 may be referred to as a reconstructor or a reconstructed block generator. The generated reconstructed signal may be used for intra prediction of a next processing target block in the current frame, or may be used for inter prediction of a next frame after being filtered as described below.

The filter 260 may improve subjective/objective image quality by applying filtering to the reconstructed signal. For example, the filter 260 may generate a modified reconstructed frame by applying various filtering methods to the reconstructed frame, and may store the modified reconstructed frame in the memory 270, specifically, in the frame buffer of the memory 270. The various filtering methods may include, for example, deblocking filtering, a sample adaptive offset, an adaptive loop filter, and a bilateral filter. The filter 260 may generate information related to the filtering, and may transmit the generated information to the entropy encoder 240. The information related to the filtering may be encoded by the entropy encoder 240 and output in a form of a bitstream.

The modified reconstructed frame transmitted to the memory 270 may be used as a reference frame in the inter predictor. When inter prediction is applied via the modified reconstructed frame, the encoding apparatus may avoid a prediction mismatch between the encoding apparatus 200 and the decoding apparatus, and may improve encoding efficiency may be improved.

The memory 270 may store the modified reconstructed frame for use as the reference frame in the inter predictor. The memory 270 may store motion information about a block from which motion information in the current frame is derived (or encoded) and/or motion information about blocks in a frame already reconstructed. The stored motion information may be transmitted to the inter predictor to be utilized as motion information about the spatial neighboring block or motion information about the temporal neighboring block. The memory 270 may store reconstructed samples of reconstructed blocks in the current frame, and may transmit the reconstructed samples to the intra predictor.

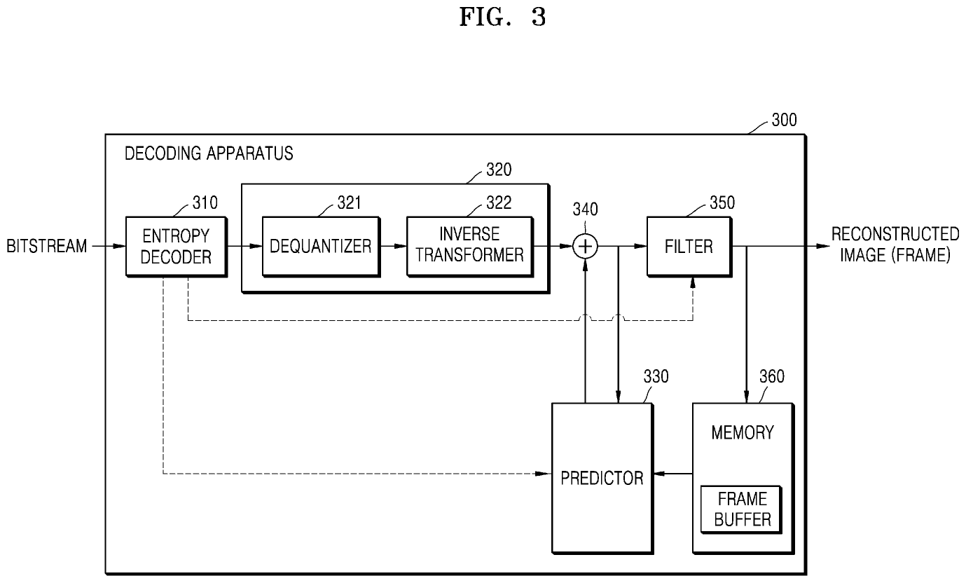

FIG. 3 is a diagram schematically illustrating a configuration of a video/image decoding apparatus to which embodiments of the disclosure are applicable. Hereinafter, a decoding apparatus may include an image decoding apparatus and/or a video decoding apparatus.

Referring to FIG. 3, the decoding apparatus 300 may include an entropy decoder 310, a residual processor 320, a predictor 330, an adder 340, a filter 350, and a memory 360. The predictor 330 may include an inter predictor and an intra predictor. The residual processor 320 may include a dequantizer 321 and an inverse transformer 322. The entropy decoder 310, the residual processor 320, the predictor 330, the adder 340, and the filter 350 may be configured as a single hardware component (e.g., a decoder chipset or processor) according to an embodiment. The memory 360 may include a frame buffer, and may be configured as a digital storage medium. The hardware component may further include the memory 360 as an internal/external component.

When a bitstream including video/image information is input, the decoding apparatus 300 may reconstruct an image according to a process in which the video/image information is processed in the encoding apparatus of FIG. 2. For example, the decoding apparatus 300 may derive units/blocks, based on block partition-related information obtained from the bitstream. The decoding apparatus 300 may perform decoding using a processing unit applied to the encoding apparatus. Therefore, the processing unit for decoding may be, for example, a superblock or a coding unit, and a coding unit may be partitioned from a superblock according to a quad-tree structure, a binary-tree structure, and/or a ternary-tree structure. One or more prediction blocks or transform units may be derived from a coding unit. A reconstructed image signal decoded and output by the decoding apparatus 300 may be reproduced via a reproducing apparatus.

The decoding apparatus 300 may receive a signal output from the encoding apparatus in a form of a bitstream, and the received signal may be decoded by the entropy decoder 310. For example, the entropy decoder 310 may parse the bitstream to derive information (e.g., video/image information) necessary for image reconstruction (or frame reconstruction). The video/image information may further include information commonly applied to a specific range, such as a tile header, a frame header, and a sequence header. The decoding apparatus may decode a frame, based on the header information. In the disclosure, signaled/received information and/or syntax elements to be described below may be decoded through the decoding procedure and may be obtained from the bitstream. For example, the entropy decoder 310 may decode the information in the bitstream, based on a coding method, such as a CDF and CABAC, and may output a value of a syntax element required for image reconstruction and a quantized value of a transform coefficient for a residual. More specifically, the CDF-based coding method may include a procedure of storing a probability distribution of symbols in a form of a CDF, selecting an appropriate CDF by analyzing context of a current block, encoding symbols at an encoder side, based on the CDF, and reconstructing syntax elements/information using the same CDF at a decoder side. The CABAC method may determine a context model by using a target syntax element/information and coding information about neighboring and coding target blocks or information about a symbol/bin coded in a previous stage, generate a bit string by predicting an occurrence probability of a bin according to the determined context model and performing arithmetic encoding on the bin at the encoder side, and generate a symbol corresponding to a value of each syntax element by predicting an occurrence probability of a bin according to the determined context model and performing arithmetic decoding on the bin at the decoder side. Here, after determining the context model, the context model may be updated using information about a coded symbol/bin for a context model of a next symbol/bin. Prediction-related information among the information decoded by the entropy decoder 310 may be provided to the predictor 330, and a residual value obtained through entropy decoding in the entropy decoder 310, that is, quantized transform coefficients and related parameter information, may be input to the residual processor 320. The residual processor 320 may derive a residual signal (residual block, residual samples, or residual sample array). Filtering-related information among the information decoded by the entropy decoder 310 may be provided to the filter 350. A receiver (not shown) for receiving a signal output from the encoding apparatus may be further configured as an internal/external element of the decoding apparatus 300, or the receiver may be a component of the entropy decoder 310. The decoding apparatus according to the disclosure may be referred to as a video/image/frame decoding apparatus, and may be divided into an information decoder (video/image/frame information decoder) and a sample decoder (video/image/frame sample decoder). The information decoder may include the entropy decoder 310, and the sample decoder may include at least one of the dequantizer 321, the inverse transformer 322, the adder 340, the filter 350, the memory 360, and the predictor 330.

The dequantizer 321 may dequantize the quantized transform coefficients to output transform coefficients. The dequantizer 321 may rearrange the quantized transform coefficients in a two-dimensional block form. In this case, the rearrangement may be performed based on a coefficient scan order executed in the encoding apparatus. The dequantizer 321 may perform dequantization on the quantized transform coefficients using a quantization parameter (e.g., quantization step size information), and obtain the transform coefficients.

The inverse transformer 322 inversely transforms the transform coefficients to acquire a residual signal (residual block or residual sample array).

The predictor may perform prediction of the current block, and may generate a predicted block including prediction samples of the current block. The predictor may determine whether intra prediction is applied or inter prediction is applied to the current block, based on the prediction-related information output from the entropy decoder 310, and determine a specific intra/inter prediction mode.

The predictor 330 may generate a prediction signal, based on various prediction methods. For example, the predictor may apply intra prediction or inter prediction for prediction of one block, and may simultaneously apply intra prediction and inter prediction, which may be referred to as compound inter-intra prediction. In this case, a mode used for the intra prediction may include the DC prediction mode, a vertical prediction mode, a horizontal prediction mode, and the SMOOTH prediction mode. Further, the predictor may be based on the intra block copy mode described above or a palette mode for the prediction of the block. As described above, the intra block copy mode is a type of intra prediction and basically performs prediction within a current frame, but may be performed similarly to inter prediction in that the mode derives a reference block, based on a vector using the current frame as a reference frame. However, since the current frame is used as the reference frame, the term “block vector” may be used for a vector for displacement instead of “motion vector”. That is, the intra block copy mode may utilize at least one of inter prediction techniques described in the disclosure. In this case, a motion vector derived through a neighboring block or the motion information stack may be referenced for deriving a block vector of the current block. For example, when the intra block copy mode is applied, the foregoing NEWMV mode may be used for deriving the block vector of the current block.

The intra predictor may predict the current block with reference to samples within a current frame. The referenced samples may be located adjacent to (neighboring) the current block, or may be located away from the current block depending on a prediction mode. Intra prediction may be performed on a transform block basis. When a plurality of transform blocks exists in a coding block, intra prediction may be performed sequentially in a raster order of the transform blocks. In this case, a procedure for deriving neighboring reference samples for intra prediction may be performed based on a transform block. A plurality of prediction modes may be considered for intra prediction. The prediction modes may include a plurality of non-directional modes and a plurality of directional modes. A prediction mode used for the current block may be signaled from the encoding apparatus to a decoding apparatus, and the prediction modes may include, for example, a DC intra prediction mode, a plurality of directional intra prediction modes, a plurality of SMOOTH intra prediction modes, and/or a PAETH intra prediction mode. The prediction modes may include an intra block copy (intrabc) mode. Whether the intra block copy mode is applied may be signaled separately. The directional prediction modes may include, for example, eight or more prediction modes depending on a prediction direction, which is, however, only for illustration, and a greater or smaller number of directional prediction modes may be used depending on a configuration. The intra predictor may also determine a prediction mode to be applied to the current block, based on a prediction mode applied to a neighboring block. In the intra block copy mode, similar to an inter prediction mode described below, a reference block is derived based on a vector, and the current frame is used as a reference frame. The vector used to derive the reference block in the intra block copy mode may be referred to as a block vector. Intra prediction may be performed based on various prediction modes, and the prediction-related information obtainable through the bitstream may include information indicating an intra prediction mode for the current block.

The inter predictor may induce a predicted block for the current block, based on a reference block (reference sample array) specified by a motion vector on a reference picture. Here, to reduce the amount of motion information transmitted in the inter prediction mode, motion information may be predicted on a block, sub-block, or sample basis, based on a correlation in motion information between a neighboring block and the current block. The motion information may include a motion vector and/or a reference frame index. The motion information may further include inter prediction direction (L0 prediction, L1 prediction, and compound prediction) information. In inter prediction, the neighboring block may include a spatial neighboring block existing within a current frame and a temporal neighboring block existing in the reference frame. A reference frame including the reference block and the reference frame including the temporal neighboring block may be the same or different. The temporal neighboring block may be referred to as a co-located reference block or a co-located block, and the reference frame including the temporal neighboring block may also be referred to as a co-located frame. For example, the inter predictor may configure a motion information stack, based on neighboring blocks, and may generate information indicating a candidate used to derive the motion vector and/or the reference frame index of the current block. The motion information stack may be referred to as a motion information list. The motion information stack may include a motion vector stack. The motion vector stack may be referred to as RefStackMv. The motion vector stack may include eight or more candidates. Information about the (maximum) number of candidates of the motion vector stack may be signaled on a frame or sequence basis. For inter prediction, a motion mode may be additionally considered. The motion mode may include a simple mode, an overlapped block motion compensation (OBMC) mode and/or a local warp mode. The OBMC mode may improve prediction performance by using motion information about a neighboring block at a left and/or upper boundary of the current block, and the local warp mode may apply an affine model in addition to translational motion compensation. Inter prediction may be performed based on various prediction modes, and the prediction-related information obtainable through the bitstream may include information indicating an inter prediction mode for the current block. For example, the inter predictor may configure a motion information stack, based on neighboring blocks, and may derive a motion vector and/or a reference frame index of the current block, based on received candidate selection information (e.g., a reference motion vector index and/or a reference frame index).

The adder 340 may add the obtained residual signal to the prediction signal (predicted block or prediction same array) output from the predictor 330 to generate a reconstructed signal (reconstructed frame, reconstructed block, or reconstructed sample array). When there is no residual for the processing target block, such as when a skip mode is applied, the predicted block may be used as a reconstructed block.

The adder 340 may be referred to as a reconstructor or a reconstructed block generator. The generated reconstructed signal may be used for intra prediction of a next processing target block in the current frame, or may be output or used for inter prediction of a next frame after being filtered as described below.

The filter 350 may improve subjective/objective image quality by applying filtering to the reconstructed signal. For example, the filter 350 may generate a modified reconstructed frame by applying various filtering methods to the reconstructed frame, and may transmit the modified reconstructed frame to the memory 360, specifically, to the frame buffer of the memory 360. The various filtering methods may include, for example, deblocking filtering, a sample adaptive offset, an adaptive loop filter, and a bilateral filter.

The (modified) reconstructed frame stored in the memory 360 may be used as a reference frame in the inter predictor. The memory 360 may store motion information about a block from which motion information in the current frame is derived (or decoded) and/or motion information about blocks in a frame already reconstructed. The stored motion information may be transmitted to the inter predictor to be utilized as motion information about the spatial neighboring block or motion information about the temporal neighboring block. The memory 360 may store reconstructed samples of reconstructed blocks in the current frame, and may transmit the reconstructed samples to the intra predictor.

In this specification, the embodiments described for each component of the encoding apparatus 200 may also be applied equally or correspondingly to the corresponding components of the decoding apparatus 300.

As described above, in performing image coding, prediction is conducted to increase compression efficiency. Through the prediction, a predicted block including prediction samples for a current block, which is a coding target block, may be generated. The predicted block includes the prediction samples in a spatial domain (or pixel domain). The predicted block is derived identically in an encoding apparatus and a decoding apparatus, and the encoding apparatus may enhance image coding efficiency by signaling information about a residual between an original block and the predicted block(residual information), rather than an original sample value of the original block, to the decoding apparatus. The decoding apparatus may derive a residual block including residual samples, based on the residual information, may generate a reconstructed block including reconstructed samples by combining the residual block and the predicted block, and may generate a reconstructed frame including the reconstructed blocks.

The residual information may be generated through transform and quantization procedures. For example, the encoding apparatus may derive a residual block between the original block and the predicted block, may perform a transform procedure on residual samples (a residual sample array) included in the residual block to derive transform coefficients, and may perform a quantization procedure on the transform coefficients to derive quantized transform coefficients, and may signal the related residual information to the decoding apparatus (via a bitstream). The residual information may include information, such as value information and position information about the quantized transform coefficients, a transform technique, a transform kernel, and a quantization parameter. The decoding apparatus may perform a dequantization/inverse transform procedure based on the residual information to derive the residual samples (or residual block). The decoding apparatus may generate a reconstructed frame, based on the predicted block and the residual block. The encoding apparatus may perform a dequantization/inverse transform on the quantized transform coefficients to derive the residual block for reference in inter prediction of a subsequent frame, and may generate a reconstructed frame, based on the residual block.

In the disclosure, at least one of quantization/dequantization and/or transform/inverse transform may be omitted. When the quantization/dequantization is omitted, the quantized transform coefficients may be referred to as transform coefficients. When the transform/inverse transform is omitted, the transform coefficients may be referred to as coefficients or residual coefficients, or may still be referred to as transform coefficients for consistency in expression.

Further, in the present disclosure, quantized transform coefficients and transform coefficients may be referred to as transform coefficients and scaled transform coefficients, respectively. In this case, residual information may include information related to transform coefficient(s), and the information related to the transform coefficient(s) may be signaled through residual coding syntax. Transform coefficients may be derived based on the residual information (or the information related to the transform coefficient(s)), and scaled transform coefficients may be derived through inverse transform (scaling) of the transform coefficients. Residual samples may be derived based on inverse transform (transform) of the scaled transform coefficients. The above description may be similarly applied and expressed in other parts of the present disclosure.

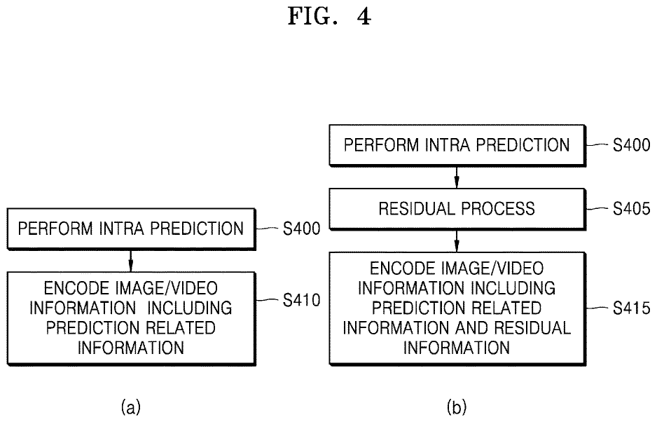

FIG. 4 illustrates examples of a residual process-based video/image encoding method.

Referring to FIG. 4, S400 may be performed by a predictor of an encoding apparatus, S410 may be performed by a residual processor of the encoding apparatus, and S420 may be performed by an entropy encoder of the encoding apparatus. Specifically, the prediction-related information may be derived by the predictor and may be encoded by the entropy encoder. The residual information may be derived by the residual processor and may be encoded by the entropy encoder. The residual information is information on residual samples. The residual information may include information on quantized transform coefficients for the residual samples. As described above, the residual samples may be transformed into transform coefficients through a transformer of the encoding apparatus, and the transform coefficients may be quantized into quantized transform coefficients through a quantizer. Information on the quantized transform coefficients may be encoded in the entropy encoder through a residual coding process.

The encoding apparatus derives prediction samples for a current block (S400). The encoding apparatus may derive the prediction samples for the current block based on the above-described inter prediction and/or intra prediction.

The encoding apparatus may perform residual process based on the prediction samples (S410). The encoding apparatus may derive residual samples based on the prediction samples. The encoding apparatus may derive the residual samples by comparing original samples of the current block with the prediction samples. The residual process may include a transform and/or quantization process for the residual samples, as described above. The encoding apparatus may generate residual information from the residual samples through the residual process. The residual information may include information on quantized transform coefficients as described above.

The encoding apparatus encodes image information including prediction-related information and/or residual information (S420). The encoding apparatus may output the encoded image information in the form of a bitstream. The prediction-related information may include information related to the prediction procedure. The residual information is information on the residual samples. The residual information may include information on quantized transform coefficients for the residual samples.

The output bitstream may be stored in a (digital) storage medium and transmitted to a decoding apparatus, or may be transmitted to the decoding apparatus through a network.

Meanwhile, as described above, the encoding apparatus may generate a reconstructed picture (including reconstructed samples and a reconstructed block) based on the reference samples and the residual samples. This is to derive the same prediction result in the encoding apparatus as performed in the decoding apparatus, thereby improving coding efficiency. Accordingly, the encoding apparatus may store the reconstructed picture (or reconstructed samples, reconstructed block) in a memory and may use the reconstructed picture as a reference picture for inter prediction. As described above, an in-loop filtering procedure and the like may be further applied to the reconstructed picture.

The decoding apparatus may perform operations corresponding to those performed by the encoding apparatus. A video/image decoding procedure based on residual process may include, for example, the following.

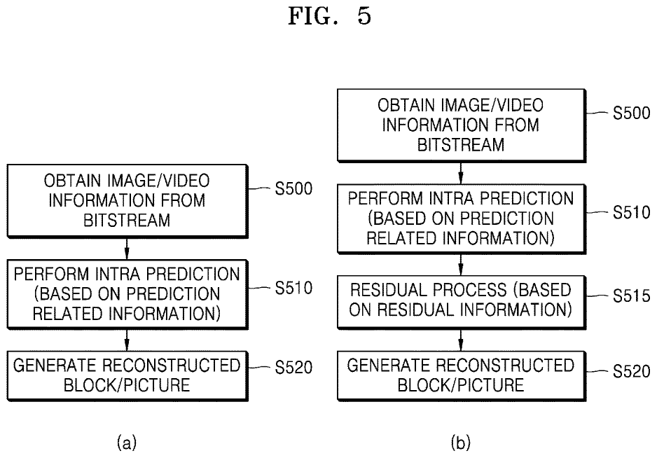

FIG. 5 illustrates examples of a residual process-based video/image decoding method.

Referring to FIG. 5, S500 may be performed by an entropy decoder of a decoding apparatus, S510 may be performed by a predictor of the decoding apparatus, S520 may be performed by a residual processor of the decoding apparatus, and S530 may be performed by an adder or a reconstructor of the decoding apparatus.

Specifically, the decoding apparatus obtains video/image information from a bitstream (S500). The video/image information may include prediction-related information and/or residual information.

The decoding apparatus performs prediction (including inter prediction and/or intra prediction) based on the prediction-related information (S510). The decoding apparatus may derive a prediction mode/type for a current block based on the prediction-related information, and may generate prediction samples in the current block based on the prediction mode/type. In this case, the decoding apparatus may perform a prediction sample filtering procedure. The prediction sample filtering may be referred to as post-filtering. Some or all of the prediction samples may be filtered by the prediction sample filtering procedure. In some cases, the prediction sample filtering process may be omitted.

The decoding apparatus performs residual process based on the residual information (S520). The decoding apparatus may derive residual samples for the current block based on the residual information. Specifically, a dequantizer of the residual processor may perform dequantization based on quantized transform coefficients derived from the residual information to derive transform coefficients, and an inverse transformer of the residual processor may perform inverse transform on the transform coefficients to derive residual samples for the current block.

The decoding apparatus generates a reconstructed block/picture (S530). The decoding apparatus may generate reconstructed samples for the current block based on the prediction samples and/or the residual samples, and may derive a reconstructed block including the reconstructed samples. A reconstructed picture for the current picture may be generated based on the reconstructed block. As described above, an in-loop filtering procedure and the like may be further applied to the reconstructed picture.

The residual information may be encoded/decoded through binarization and coding methods described in the present disclosure. For example, the residual information may be binarized through fixed-length binarization, truncated Rice binarization, truncated unary binarization, or the like. For example, the residual information may be encoded/decoded through entropy coding (e.g., CABAC, CAVLC) or bypass coding.

Meanwhile, intra prediction modes for intra prediction may include the following.

For example, the intra prediction mode may include the following intra prediction modes. The intra prediction modes in Table 1 may be intra prediction modes for a luma component or a chroma component.

TABLE 1

| Intra prediction mode number | Classification |
|---|---|
| 0 | DC intra prediction mode |
| 1~8 | Directional intra prediction modes |
| 9~11 | SMOOTH intra prediction modes |
| 12 | PAETH intra prediction mode |

In a DC intra prediction mode, the current block may be predicted using an average value of the neighboring reference samples of the current block. The DC intra prediction mode may be referred to as a DC prediction mode or DC mode. In directional intra prediction modes, prediction may be performed using a value of a reference sample located in a specific direction based on a sample position within the current block. The directional intra prediction modes may basically include a horizontal mode, a horizontal-left-down (D203) mode, a horizontal-left-up (D157) mode, a diagonal-left-up (D135) mode, a vertical mode, a vertical-left-up (D133) mode, a vertical-right-up (D67) mode, and a diagonal-right-up (D45) mode. Further, an angle delta value may be additionally signaled to indicate a more detailed intra prediction direction. In SMOOTH intra prediction modes, prediction may be performed by interpolating values of the neighboring reference samples of the current block. In this case, vertical interpolation, horizontal interpolation, or both vertical interpolation and horizontal interpolation may be performed depending on a mode. In a PAETH intra prediction mode, prediction may be performed using the top-left reference sample, a left reference sample, and a top reference sample of the current block. In this case, prediction may be performed using a difference between the left reference samples and the top-left reference sample and a difference between the top reference sample and the top-left reference sample.

Meanwhile, a chroma from luma (CFL) intra prediction mode for a chroma block may be further considered. The intra prediction modes of Table 2 may be intra prediction modes for a chroma component.

TABLE 2

| Intra prediction mode number | Classification |
|---|---|
| 0 | DC intra prediction mode |
| 1~8 | Directional intra prediction modes |
| 9~11 | SMOOTH intra prediction modes |
| 12 | PAETH intra prediction mode |
| 13 | CFL intra prediction mode |

In the CFL intra prediction mode, a chroma block may be predicted based on a linear or nonlinear model using a reconstructed luma block. For example, the CFL intra prediction mode may be assigned intra prediction mode number 13.

For example, prediction for a chroma block may be performed using CFL intra prediction.

For example, prediction for a chroma component may be performed based on a luma component. That is, prediction samples of the chroma block may be derived based on a luma block. In addition, the luma block may correspond to the chroma block. In other words, the luma block and the chroma block may be located at the same position.

In addition, as described below, the luma component may include a luma sample. For example, the luma component may include a luma sample of a corresponding luma block corresponding to the chroma block, and may include neighboring luma samples of the corresponding luma block.

For example, when an intra prediction mode for the chroma block is a CFL intra prediction mode, CFL intra prediction may be performed. Alternatively, the CFL prediction may be performed based on a flag indicating whether the CFL prediction is applied.

Meanwhile, CFL prediction may be performed based on a size of a current block. For example, when the size of the current block is less than or equal to a specific size, the CFL prediction may be performed. In this case, the specific size may be one of 4, 8, 16, 32, 64, or 128.

In addition, CFL prediction may be performed based on a width and/or a height of the current block. For example, when a maximum value of the width or the height of the current block is less than or equal to a specific value, the CFL prediction may be performed. In this case, the specific value may be one of 4, 8, 16, 32, or 64.

Meanwhile, for CFL prediction, CFL-related information may be signaled.

For example, when an intra prediction mode for a chroma block is “UV_CFL_PRED,” CFL-related information may be signaled as shown in the table below.

TABLE 3

| | Type |
|---|---|
| intra_frame_mode_info( ) [ | |
| skip = 0 | |
| if ( SegIdPreSkip ) | |
| intra_segment_id( ) | |
| skip_mode = 0 | |
| read_skip( ) | |
| if (!SegIdPreSkip ) | |
| intra_segment_Id ( ) | |
| read_cdef( ) | |
| read_delta_qindex( ) | |
| read_delta_If( ) | |
| ReadDeltas = 0 | |
| RefFrame[ 0 ] = INTRA_FRAME | |
| RefFrame[ 1 ] = NONE | |
| if ( allow_intrabc ) { | |
| use_intrabc | S( ) |
| } else { | |
| use_intrabc = 0 | |
| } | |
| if ( use_intrabc ) { | |
| is_inter = 1 | |
| YMode = DC_PRED | |
| UVMode = DC_PRED | |
| motion_mode = SIMPLE | |
| compound_type = COMPOUND_AVERAGE | |
| PaletteSizeY = 0 | |
| PaletteSizeUV = 0 | |
| interp_filter[ 0 ] = BILINEAR | |
| interp_filter[ 1 ] = BILINEAR | |
| find_mv_stack( 0 ) | |
| assign_mv( 0 ) | |
| } else { | |
| is_inter = 0 | |
| intra_frame_y_mode | S( ) |
| YMode = intra_frame_y_mode | |
| intra_angle_info_y( ) | |
| if ( HasChroma ) { | |
| uv_mode | S( ) |
| UVMode = uv_mode | |
| if ( UVMode == UV_CFL_PRED ) { | |
| read_cfl_alphas( ) | |
| } | |
| intra_angle_info_uv( ) | |
| } | |
| PaletteSizeY = 0 | |
| PaletteSizeUV = 0 | |
| if ( MiSize >= BLOCK_8X8 && | |
| Block_Width[ MiSize ] <= 64 && | |
| Block_Height[ MiSize ] <= 64 && | |
| allow_screen_content_tools ) { | |
| palette_mode_info( ) | |
| } | |
| filter_intra_mode_info( ) | |
| } | |
| } | |

Alternatively, for example, when an intra prediction mode for a chroma block is “UV_CFL_PRED,” CFL-related information may be signaled as shown in the table below.

TABLE 4

| | Type |
|---|---|
| intra_block_mode_info( ) [ | |
| RefFrame[ 0 ] = INTRA_FRAME | |
| RefFrame[ 1 ] = NONE | |
| y_mode | |
| YMode = y_mode | |
| intra_angle_info_y( ) | |
| if ( HasChroma ) { | |
| uv_mode | S( ) |
| UVMode = uv_mode | |
| if ( UVMode == UV_CFL_PRED ) { | |
| read_cfl_alphas( ) | |
| } | |
| intra_angle_info_uv( ) | |
| } | |
| PaletteSizeY = 0 | |
| PaletteSizeUV = 0 | |
| if ( MiSize >= BLOCK_8X8 && | |
| Block_Width[ MiSize ] <= 64 && | |
| Block_Height[ MiSize ] <= 64 && | |
| allow_screen_content_tools ) | |
| palette_mode_info( ) | |
| filter_intra_mode_info( ) | |
| } | |

Referring to Tables 3 and 4, when the intra prediction mode is “UV_CFL_PRED,” “read_cfl_alphas( )” may be derived, and CFL-related information may be signaled.

In addition, the CFL-related information may be represented as shown in the table below.

TABLE 5

| | Type |
|---|---|
| read_cfl_alphas( ) { | S( ) |
| cfl_alpha_sign | |
| signU = (cfl_alpha_signs + 1 ) / 3 | |
| signV = (cfl_alpha_signs + 1 ) % 3 | |
| if ( signU != CFL_SIGN_ZERO ) { | |
| cfl_alpha_u | S( ) |
| CflAlphaU = 1 + cfl_alpha_u | |
| if ( signU == CFL_SIGN_NEG ) | |
| CflAlphaU = −CflAlphaU | |
| } else { | |
| CflAlphaU = 0 | |
| } | |
| if ( signV != CFL_SIGN_ZERO ) { | |
| cfl_alpha_v | S( ) |
| CflAlphaV = 1 + cfl_alpha_v | |
| if (signV == CFL_SIGN_NEG ) | |
| CflAlphaV = −CflAlphaV | |
| } else { | |
| CflAlphaV = 0 | |
| } | |

In addition, semantics of the CFL-related information may be represented as shown in the table below.

TABLE 6
cfl_alpha_signs contains the sign of the alpha values for U and V packed
together into a single syntax element with 8 possible values. (The
combination of two zero signs is prohibited as it is redundant with DC
Intra prediction.)
signU contains the sign of the alpha value for the U component:
signV contains the sign of the alpha value for the V component with the
same interpretation as for signU.
cfl_alpha_u contains the absolute value of alpha minus one for the U
component.
cfl_alpha_v contains the absolute value of alpha minus one for the V
component.
CflAlphaU contains the signed value of the alpha component for the U
component.
CflAlphaV contains the signed value of the alpha component for the V
component.

Referring to Table 6, “cfi_alpha_signs” may be information regarding signs of alpha values for chroma components, “signU” may be information regarding a sign of an alpha value for a U component, and “signV” may be information regarding a sign of an alpha value for a V component. In addition, “cfi_alpha_u” may be information regarding an absolute value of alpha for the U component, and “cfi_alpha_v” may be information regarding an absolute value of alpha for the V component. Further, “CflAlphaU” may be information including a sign value of an alpha component for the U component, and “CflAlphaV” may be information including a sign value of an alpha component for the V component.

For example, information regarding signs of alpha values for chroma components may be signaled. Specifically, information regarding signs of alpha values for the U component and the V component may be signaled. In this case, the information regarding signs of alpha values for the U component and the V component may be represented as “cfl_alpha_signs”.

For example, information regarding a sign of an alpha value for the U component may be derived based on the information regarding signs of alpha values for chroma components. In addition, information regarding a sign of an alpha value for the V component may be derived based on the information regarding signs of alpha values for chroma components. In this case, the information regarding the sign of the alpha value for the U component may be represented as “signU”, and the information regarding the sign of the alpha value for the V component may be represented as “signV”.

In addition, an alpha value for the U component may be determined according to a value of the information regarding the sign of the alpha value for the U component. For example, when the value of the information regarding the sign of the alpha value for the U component is 0, the information may indicate “CFL_SIGN_ZERO”. In addition, when the value of the information regarding the sign of the alpha value for the U component is 1, the information may indicate “CFL_SIGN_NEG”. In addition, when the value of the information regarding the sign of the alpha value for the U component is 2, the information may indicate “CFL_SIGN_POS”.

For example, when the value of the information regarding the sign of the alpha value for the U component is 0, information regarding an absolute value of alpha for the U component may not be signaled. In this case, the alpha value for the U component may be 0. In addition, when the value of the information regarding the sign of the alpha value for the V component is 0, information regarding an absolute value of alpha for the V component may not be signaled. In this case, the alpha value for the V component may be 0.

In addition, for example, when the value of the information regarding the sign of the alpha value for the U component is 1, the sign of the alpha value for the U component may be changed. In addition, when the value of the information regarding the sign of the alpha value for the V component is 1, the sign of the alpha value for the V component may be changed.

For example, when the value of the information regarding the sign of the alpha value for the U component is 2, the sign of the alpha value for the U component may not be changed. In addition, when the value of the information regarding the sign of the alpha value for the V component is 1, the sign of the alpha value for the V component may not be changed.

For example, information regarding an absolute value of alpha for the U component may be signaled. In addition, information regarding an absolute value of alpha for the V component may be signaled. Specifically, information regarding an absolute value of (alpha−1) for the U component may be signaled, and information regarding an absolute value of (alpha−1) for the V component may be signaled. In this case, the information regarding the absolute value of alpha for the U component may be represented as “cfl_alpha_u”, and the information regarding the absolute value of alpha for the V component may be represented as “cfl_alpha_v”.

For example, information regarding an absolute value of alpha for the U component may be derived based on the information regarding the sign of the alpha value for the U component. In addition, information regarding an absolute value of alpha for the V component may be derived based on the information regarding the sign of the alpha value for the V component.

In addition, for example, when the information regarding the sign of the alpha value for the U component has a specific value, the information regarding the absolute value of alpha for the U component may not be derived. In this case, the alpha value for the U component may be 0. In addition, when the information regarding the sign of the alpha value for the V component has a specific value, the information regarding the absolute value of alpha for the V component may not be derived. In this case, the alpha value for the V component may be 0.

For example, an alpha value for the U component may be derived based on the information regarding the absolute value of alpha for the U component, and an alpha value for the V component may be derived based on the information regarding the absolute value of alpha for the V component. Specifically, the alpha value for the U component may be derived as the information regarding the absolute value of alpha for the U component+1, and the alpha value for the V component may be derived as the information regarding the absolute value of alpha for the V component+1. In this case, the alpha value for the U component may be represented as “CflAlphaU”, and the alpha value for the V component may be represented as “CflAlphaV”.

In addition, for example, the alpha value for the U component may include information regarding a sign of alpha for the U component or information regarding a sign value of an alpha component for the U component. In addition, the alpha value for the V component may include information regarding a sign of alpha for the V component or information regarding a sign value of an alpha component for the V component.

In this case, a sign of the alpha value for the U component may be determined based on the information regarding the sign of the alpha value for the U component. For example, when the information regarding the sign of the alpha value for the U component indicates a negative value, the sign of the alpha value for the U component may be changed. Specifically, when the information regarding the sign of the alpha value for the U component indicates a negative value, the alpha value for the U component may be multiplied by −1 so that a new alpha value may be derived. In this case, the information regarding the sign of the alpha value for the U component may be represented as “CFL_SIGN_NEG”. In addition, when the information regarding the sign of the alpha value for the U component indicates a positive value, the information regarding the sign of the alpha value for the U component may be represented as “CFL_SIGN_POS”.

In addition, for example, a sign of the alpha value for the V component may be determined based on the information regarding the sign of the alpha value for the V component. For example, when the information regarding the sign of the alpha value for the V component indicates a negative value, the sign of the alpha value for the V component may be changed. Specifically, when the information regarding the sign of the alpha value for the V component indicates a negative value, the alpha value for the V component may be multiplied by −1 so that a new alpha value may be derived. In this case, the information regarding the sign of the alpha value for the V component may be represented as “CFL_SIGN_NEG”. In addition, when the information regarding the sign of the alpha value for the V component indicates a positive value, the information regarding the sign of the alpha value for the V component may be represented as “CFL_SIGN_POS”.

In addition, a prediction parameter used for CFL prediction for the U component may be derived based on the information regarding the absolute value of alpha for the U component. In addition, a prediction parameter used for CFL prediction for the V component may be derived based on the information regarding the absolute value of alpha for the V component.

Meanwhile, the U component and the V component of the chroma component described above may be a Cb component and a Cr component of the chroma component, respectively.

In addition, when intra prediction for a chroma block is performed, a CFL (Chroma From Luma) mode may be used as one of intra prediction modes. For example, CFL may be a method for performing prediction for prediction samples for a U component and prediction samples for a V component.

For example, CFL prediction may be performed based on reconstructed luma samples of a luma block and chroma DC prediction. For example, prediction samples of the chroma block may be derived based on the reconstructed luma samples of the luma block and the chroma DC prediction. Here, the chroma DC prediction may be chroma prediction samples on which DC prediction is performed, or may be chroma prediction samples derived based on neighboring chroma samples.

In addition, CFL prediction may be performed based on reconstructed luma samples of a luma block, neighboring luma samples of the luma block, and chroma DC prediction. For example, prediction samples of a chroma block may be derived based on the reconstructed luma samples of the luma block, the neighboring luma samples of the luma block, and the chroma DC prediction.

Here, the chroma DC prediction may be chroma prediction samples on which DC prediction is performed, or may be chroma prediction samples derived based on neighboring chroma samples.

In addition, prediction samples of a chroma block may be derived based on reconstructed luma samples of a luma block, a scaling parameter, and chroma DC prediction.

Subsampling may be performed on the reconstructed luma samples of the luma block. Reconstructed luma samples on which subsampling is performed may be subsampled reconstructed luma samples or reconfigured luma samples. In this case, performing subsampling on the reconstructed luma samples may mean that downsampling is performed on the reconstructed luma samples. Specifically, subsampling may be performed on the reconstructed luma samples using an n-tap filter. In this case, n in the n-tap filter may be a positive integer. For example, the n-tap filter may be a 3-tap, 4-tap, 5-tap, 6-tap, or 7-tap filter. For example, a type of a filter used for the subsampling may be determined based on signaled information. In other words, the filter used for the subsampling may be determined based on the signaled information. In addition, the information may be signaled through a sequence header.

In addition, an average value of a luma component may be derived based on the subsampled reconstructed luma samples. For example, an average value of the subsampled reconstructed luma samples may be configured based on 3 fractional-bit precision. In this case, the average value of the subsampled reconstructed luma samples may be referred to as an average value of reconstructed luma intensity.

In addition, scaled luma samples may be derived based on the subsampled reconstructed luma samples and the average value of the luma component.

For example, the scaled luma samples may be derived using a scaling parameter based on the subsampled reconstructed luma samples and the average value of the luma component. Specifically, the scaled luma samples may be derived by multiplying the scaling parameter by a difference value between the subsampled reconstructed luma samples and the average value of the luma component.

The scaling parameter may be derived based on signaled CFL-related information. Specifically, the scaling parameter may be derived based on signaled scaling parameter-related information. For example, the scaling parameter may be derived based on the CFL-related information described above.

For example, the scaling parameter may be derived based on “CflAlphaU”. In addition, the scaling parameter may be derived based on “CflAlphaV”. Specifically, a scaling parameter used for deriving chroma prediction samples for the U component may be derived based on “CflAlphaU”, and a scaling parameter used for deriving chroma prediction samples for the V component may be derived based on “CflAlphaV”.

In addition, the scaling parameter may be derived based on neighboring reference samples of the luma block or neighboring reference samples of the chroma block. For example, the scaling parameter may be derived based on neighboring reference samples of the luma block, may be derived based on neighboring reference samples of the chroma block, or may be derived based on neighboring reference samples of the luma block and neighboring reference samples of the chroma block.

In this case, neighboring reference samples of the luma block may include top neighboring reference samples of the luma block and left neighboring reference samples of the luma block. Alternatively, the neighboring reference samples of the luma block may include top-right reference samples and bottom-right reference samples of the luma block. Alternatively, the neighboring reference samples of the luma block may include top neighboring reference samples, left neighboring reference samples, top-right neighboring samples, bottom-left neighboring reference samples, and top-left neighboring reference samples of the luma block.

In addition, neighboring reference samples of the chroma block may include top neighboring reference samples of the chroma block and left neighboring reference samples of the chroma block. Alternatively, the neighboring reference samples of the chroma block may include top-right reference samples and bottom-right reference samples of the chroma block. Alternatively, the neighboring reference samples of the chroma block may include top neighboring reference samples, left neighboring reference samples, top-right neighboring samples, bottom-left neighboring reference samples, and top-left neighboring reference samples of the chroma block.

In this case, neighboring reference samples of the luma block may be neighboring reference samples on which subsampling is performed. For example, subsampling may be performed on the luma block and the neighboring reference samples of the luma block, and the scaling parameter may be derived based on the neighboring reference samples on which the subsampling is performed. That is, the neighboring reference samples of the luma block may include subsampled neighboring reference samples.

In addition, the scaling parameter may be modified. For example, the scaling parameter derived based on signaled information may be derived based on reconstructed chroma samples and reconstructed luma samples. The modified scaling parameter may be derived based on the following equation.

$$α = argmin sum {( Rec\_c - α * Rec\_y )}^{\hat{}} 2 \qquad [ Equation 1 ]$$

Here, Rec_c may represent reconstructed chroma samples, Rec_y may represent reconstructed luma samples, a on a right side of the equation may represent a scaling parameter derived based on signaled information, and a on a left side of the equation may represent a modified scaling parameter. The modified scaling parameter may be referred to as an updated scaling parameter.

For example, the scaling parameter a may be modified based on reconstructed chroma samples and reconstructed luma samples. In this case, the reconstructed chroma samples may include neighboring chroma samples of a current chroma block, and the reconstructed luma samples may include neighboring luma samples of the luma block. In addition, the reconstructed chroma samples may include chroma samples included in the current chroma block, and the reconstructed luma samples may include luma samples included in the luma block.

Reconstructed chroma samples used for deriving the modified scaling parameter may include top neighboring samples and left neighboring samples of the chroma block. Alternatively, the reconstructed chroma samples may include only the top neighboring samples of the chroma block or may include only the left neighboring samples of the current block. In addition, the reconstructed chroma samples may include top-right neighboring samples of the chroma block and bottom-left neighboring samples of the current block. Alternatively, the reconstructed chroma samples may include only the top-right neighboring samples of the chroma block or may include only the bottom-left neighboring samples of the chroma block. In addition, the reconstructed chroma samples may include a top-left neighboring sample of the chroma block.

In addition, reconstructed luma samples used for deriving the modified scaling parameter may include top neighboring samples and left neighboring samples of the luma block. Alternatively, the reconstructed luma samples may include only the top neighboring samples of the luma block or may include only the left neighboring samples of the luma block. In addition, the reconstructed luma samples may include top-right neighboring samples of the luma block and bottom-left neighboring samples of the current block. Alternatively, the reconstructed luma samples may include only the top-right neighboring samples of the luma block or may include only the bottom-left neighboring samples of the luma block. In addition, the reconstructed luma samples may include a top-left neighboring sample of the luma block.

In this case, the reconstructed luma samples may be luma samples on which subsampling is performed. For example, subsampling may be performed on the luma block and neighboring samples of the luma block, and the scaling parameter may be derived based on the neighboring samples on which the subsampling is performed. That is, the reconstructed luma samples may include subsampled neighboring samples. In addition, the reconstructed luma samples may include luma samples included in a subsampled luma block.

When the modified scaling parameter is derived, the scaled luma samples may be derived using the modified scaling parameter based on the subsampled reconstructed luma samples and the average value of the luma component.

Meanwhile, it may be determined whether the scaling parameter is derived based on the signaled CFL-related information or derived based on neighboring reference samples of the luma block or neighboring reference samples of the chroma block.

For example, whether the scaling parameter is derived based on the signaled CFL-related information or derived based on neighboring reference samples of the luma block or neighboring reference samples of the chroma block may be determined based on information indicating whether the scaling parameter is derived based on the signaled CFL-related information or derived based on neighboring reference samples of the luma block or neighboring reference samples of the chroma block. In addition, the CFL-related information may be signaled based on the information.

In addition, whether the scaling parameter is derived based on the signaled CFL-related information or derived based on neighboring reference samples of the luma block or neighboring reference samples of the chroma block may be determined based on at least one of a size, a shape, a depth, a partition structure, or color formats of the block. For example, when a size of the current block is less than a threshold value, the CFL-related information may be signaled so that the scaling parameter may be derived.

In addition, it may be determined whether to use the scaling parameter derived based on the signaled CFL-related information or to use the modified scaling parameter. For example, whether to use the scaling parameter derived based on the signaled CFL-related information or to use the modified scaling parameter may be determined based on information indicating whether to use the scaling parameter derived based on the signaled CFL-related information or the modified scaling parameter. That is, information indicating whether to use the modified scaling parameter may be signaled. In this case, the information indicating whether to use the modified scaling parameter may be signaled after the information indicating whether the scaling parameter is derived based on the signaled CFL-related information or derived based on neighboring reference samples of the luma block or neighboring reference samples of the chroma block.

For example, information indicating whether to use the modified scaling parameter may be signaled through a bitstream. When a value of the information is 1, the modified scaling parameter may be derived so that the scaled luma samples may be derived, and when the value of the information is 0, the scaled luma samples may be derived using the signaled scaling parameter described above. Alternatively, when the value of the information is 1, the scaled luma samples may be derived using the signaled scaling parameter, and when the value of the information is 0, the modified scaling parameter may be derived so that the scaled luma samples may be derived.

In addition, whether to use the scaling parameter derived based on the signaled CFL-related information or to use the modified scaling parameter may be determined based on at least one of a size, a shape, a depth, a partition structure, or color formats of the block.

In addition, whether the scaling parameter is derived based on the signaled CFL-related information or derived based on neighboring reference samples of the luma block or neighboring reference samples of the chroma block may be determined based on information indicating whether the scaling parameter is derived based on neighboring reference samples of the luma block or neighboring reference samples of the chroma block or whether the modified scaling parameter is used.

In addition, index information indicating whether the scaling parameter is derived based on the signaled CFL-related information, derived based on neighboring reference samples of the luma block or neighboring reference samples of the chroma block, or whether the modified scaling parameter is used may be signaled.

For example, when the information has a first value, the scaling parameter may be derived based on the signaled CFL-related information. When the information has a second value, the scaling parameter may be derived based on neighboring reference samples of the luma block or neighboring reference samples of the chroma block. When the information has a third value, the modified scaling parameter may be derived based on the scaling parameter.

Prediction samples of a chroma block may be derived based on the scaled luma samples and chroma DC prediction. Here, the chroma DC prediction may be chroma prediction samples on which DC prediction is performed, or may be chroma prediction samples derived based on neighboring chroma samples.

Alternatively, the chroma DC prediction may be chroma prediction samples derived based on neighboring chroma samples of the chroma block. For example, prediction samples of the chroma block may be derived based on the following equation.

$$Pred\_c = α ( Rec\_y - DC\_y ) + DC\_c \qquad [ Equation 2 ]$$

Here, Pred_c denotes prediction samples of the chroma block, Rec_y denotes reconstructed luma samples, DC_y denotes luma prediction samples on which DC prediction is performed, DC_c denotes chroma prediction samples on which DC prediction is performed, and a denotes a scaling parameter.

For example, a may denote a scaling parameter derived based on signaled information. Alternatively, a may denote a scaling parameter derived based on neighboring reference samples of the luma block or neighboring reference samples of the chroma block as described above. Alternatively, a may denote the above-described modified scaling parameter.

In addition, for example, DC_y may denote luma prediction samples on which DC prediction is performed. In this case, the luma prediction samples on which DC prediction is performed may be derived based on neighboring luma samples of a reconstructed luma block including the reconstructed luma samples. Alternatively, the luma prediction samples on which DC prediction is performed may be derived based on luma samples on which subsampling is performed. That is, subsampling may be performed on the reconstructed luma block and neighboring luma samples of the reconstructed luma block, and the luma prediction samples on which DC prediction is performed may be derived based on the subsampled neighboring luma samples.

In addition, prediction samples of a chroma block may be derived based on reconstructed luma samples of a luma block, luma DC prediction, a scaling parameter, and chroma DC prediction.

Subsampling may be performed on the reconstructed luma samples of the luma block. The reconstructed luma samples on which subsampling is performed may be referred to as subsampled reconstructed luma samples or reconstructed luma samples. In this case, performing subsampling on the reconstructed luma samples may mean performing downsampling on the reconstructed luma samples.

The luma DC prediction may be luma prediction samples on which DC prediction is performed, or may be luma prediction samples derived based on neighboring luma samples.

In addition, scaled luma samples may be derived based on the subsampled reconstructed luma samples and the luma DC prediction.

For example, the scaled luma samples may be derived by applying a scaling parameter to the subsampled reconstructed luma samples and the luma DC prediction. Specifically, the scaled luma samples may be derived by multiplying the scaling parameter by a difference value between the subsampled reconstructed luma samples and the luma DC prediction.

The scaling parameter may be derived based on signaled CFL-related information. Specifically, the scaling parameter may be derived based on signaled scaling parameter-related information. For example, the scaling parameter may be derived based on the above-described CFL-related information.

For example, the scaling parameter may be derived based on “CflAlphaU.” In addition, the scaling parameter may be derived based on “CflAlphaV.” Specifically, a scaling parameter used to derive chroma prediction samples for a U component may be derived based on “CflAlphaU,” and a scaling parameter used to derive chroma prediction samples for a V component may be derived based on “CflAlphaV.”

In addition, the scaling parameter may be modified. For example, the scaling parameter derived based on signaled information may be modified based on reconstructed chroma samples and reconstructed luma samples. In this case, as described above, the scaling parameter may be modified based on Equation 1. That is, the scaling parameter a may be modified based on the reconstructed chroma samples and the reconstructed luma samples. In this case, the reconstructed chroma samples may include neighboring chroma samples of a current chroma block, and the reconstructed luma samples may include neighboring luma samples of a luma block.

Prediction samples of a chroma block may be derived based on the scaled luma samples and chroma DC prediction. Here, the chroma DC prediction may be chroma prediction samples on which DC prediction is performed, or may be chroma prediction samples derived based on neighboring chroma samples.

Meanwhile, neighboring reference samples used in a CFL prediction process may include top reference samples and left reference samples of a current block. For example, neighboring reference samples of the current block may include top-right reference samples and bottom-left reference samples of the current block. In addition, neighboring reference samples of the current block may include top-right reference samples and left reference samples of the current block. In addition, neighboring reference samples of the current block may include top reference samples and bottom-left reference samples of the current block. In addition, neighboring reference samples of the current block may include top reference samples, left reference samples, top-right reference samples, bottom-left reference samples, and a top-left reference sample of the current block. In this case, the current block may be a luma block or a chroma block. As described above, reference samples of the luma block and/or reference samples of the chroma block may be used to derive the scaling parameter in the CFL prediction.

For example, top reference samples and left reference samples of the luma block and/or top reference samples and left reference samples of the chroma block may be used to derive the scaling parameter. In addition, top-right reference samples and bottom-left reference samples of the luma block and/or top-right reference samples and bottom-left reference samples of the chroma block may be used to derive the scaling parameter. In addition, top-right reference samples and left reference samples of the luma block and/or top-right reference samples and left reference samples of the chroma block may be used to derive the scaling parameter. In addition, top reference samples and bottom-left reference samples of the luma block and/or top reference samples and bottom-left reference samples of the chroma block may be used to derive the scaling parameter. In addition, top reference samples, left reference samples, top-right reference samples, bottom-left reference samples, and a top-left reference sample of the luma block and/or top reference samples, left reference samples, top-right reference samples, bottom-left reference samples, and a top-left reference sample of the chroma block may be used to derive the scaling parameter.

In addition, information indicating which reference samples among neighboring reference samples of the current block are used to perform CFL prediction may be signaled. That is, based on the information, it may be determined whether to use top reference samples and left reference samples of the current block, whether to use top-right reference samples and bottom-left reference samples of the current block, whether to use top-right reference samples and left reference samples of the current block, whether to use top reference samples and bottom-left reference samples of the current block, or whether to use top reference samples, left reference samples, top-right reference samples, bottom-left reference samples, and a top-left reference sample of the current block.

Meanwhile, subsampling may be performed on the reconstructed luma block based on a 4-tap filter, a 5-tap filter, or a 6-tap filter.

For example, when subsampling is performed based on the 4-tap filter, luma samples used for subsampling may include a luma sample located at a top-left of a corresponding luma sample position of a chroma sample, a luma sample located at a top-right thereof, a luma sample located at a bottom-left thereof, and a luma sample located at a bottom-right thereof.

In addition, when subsampling is performed based on the 5-tap filter, luma samples used for subsampling may include a luma sample located at a left of a corresponding luma sample position of a chroma sample, a luma sample located at a top thereof, a luma sample located at a right thereof, a luma sample located at a bottom thereof, and a luma sample located at the corresponding luma sample position.

In addition, when subsampling is performed based on the 6-tap filter, luma samples used for subsampling may include a luma sample located at a top-left of a corresponding luma sample position of a chroma sample, a luma sample located at a top thereof, a luma sample located at a top-right thereof, a luma sample located at a bottom-left thereof, a luma sample located at a bottom thereof, and a luma sample located at a bottom-right thereof.

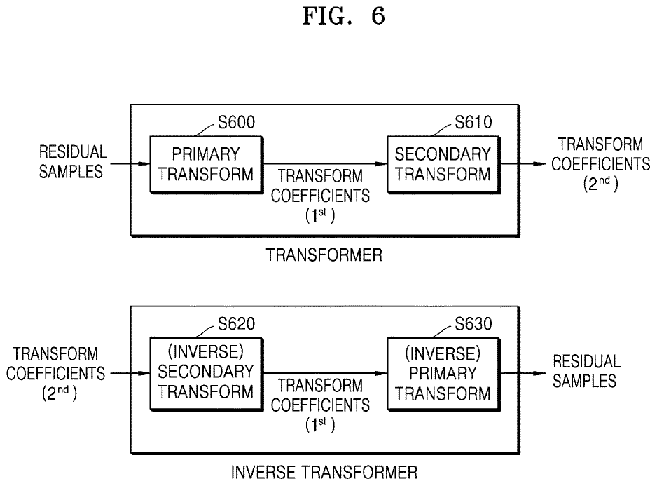

FIG. 6 exemplarily illustrates a multiple transform technique according to the present disclosure.

Referring to FIG. 6, a transformer may correspond to the transformer in the encoding apparatus of FIG. 2 described above, and an inverse transformer may correspond to the inverse transformer in the encoding apparatus of FIG. 2 or the inverse transformer in the decoding apparatus of FIG. 3 described above.

The transformer may perform a primary transform based on residual samples (a residual sample array) in a residual block to derive (primary) transform coefficients (S600). The primary transform may be referred to as a core transform. Here, the primary transform may be based on multiple transform selection (MTS), and when multiple transforms are applied as the primary transform, it may be referred to as multiple core transforms.

The transformer may perform a secondary transform based on the (primary) transform coefficients to derive modified (secondary) transform coefficients (S610). The primary transform is a transform from a spatial domain to a frequency domain, and the secondary transform may represent transforming into a more compact representation using correlation between the (primary) transform coefficients.

For example, the secondary transform may include a non-separable transform. In this case, the secondary transform may be referred to as a non-separable secondary transform (NSST) or a mode-dependent non-separable secondary transform (MDNSST). The non-separable secondary transform may represent a transform that generates modified transform coefficients (or secondary transform coefficients) for a residual signal by secondarily transforming the (primary) transform coefficients derived through the primary transform based on a non-separable transform matrix. Here, the transform may be applied at once based on the non-separable transform matrix without separately applying vertical transform and horizontal transform (or independently applying horizontal transform and vertical transform) to the (primary) transform coefficients.

That is, the non-separable secondary transform may represent a transform method that generates modified transform coefficients (or secondary transform coefficients) without separating vertical and horizontal components of the (primary) transform coefficients, for example, by rearranging two-dimensional signals (transform coefficients) into one-dimensional signals along a predetermined direction and then applying the non-separable transform matrix. In other words, it may represent a transform method in which the signals are first rearranged into one-dimensional signals in a row-first direction or a column-first direction, and then modified transform coefficients (or secondary transform coefficients) are generated based on the non-separable transform matrix.

In addition, the inverse transformer may perform a series of procedures in a reverse order of the procedures performed by the transformer described above. The inverse transformer may receive (dequantized) transform coefficients, perform a secondary inverse transform to derive (primary) transform coefficients (S620), and perform a primary inverse transform on the (primary) transform coefficients to obtain a residual block (residual samples) (S630). Here, the primary transform coefficients may be referred to as modified transform coefficients on the side of the inverse transformer. As described above, the encoding apparatus and/or the decoding apparatus may generate a reconstructed block based on the residual block and a predicted block, and may generate a reconstructed picture based thereon.

In the present disclosure, a primary transform may be referred to as a core transform. Here, the primary transform may be based on multiple transform selection (MTS), and when a transform kernel selected from among a plurality of transform kernel types is applied as the primary transform, it may be referred to as a multiple core transform.

The multiple core transform may represent a transform method using DCT (Discrete Cosine Transform) 2, DST (Discrete Sine Transform) 7, DCT 8, and the like. That is, the multiple core transform may represent a transform method for transforming a residual signal (or a residual block) in a spatial domain into transform coefficients (or primary transform coefficients) in a frequency domain based on a plurality of transform kernels selected from among DCT 2, DST 7, DCT 8, and DST 1. Here, the primary transform coefficients may be referred to as temporary transform coefficients from the perspective of the transformer.

In other words, when a conventional transform method is applied, a transform from a spatial domain to a frequency domain for a residual signal (or a residual block) may be performed based on DCT 2, thereby generating transform coefficients. In contrast, when a multiple core transform is applied, a transform from the spatial domain to the frequency domain for the residual signal (or the residual block) may be performed based on DCT 2, DST 7, DCT 8, and/or DST 1, thereby generating transform coefficients (or primary transform coefficients). Here, DCT 2, DST 7, DCT 8, and DST 1 may be referred to as transform types, transform kernels, or transform cores. These DCT/DST transform types may be defined based on basis functions.

When the multiple core transform is performed, a vertical transform kernel and a horizontal transform kernel for a target block (a block to which the transform is applied) may be selected from among transform kernels, a vertical transform for the target block may be performed based on the vertical transform kernel, and a horizontal transform for the target block may be performed based on the horizontal transform kernel. Here, the horizontal transform may represent a transform for horizontal components of the target block, and the vertical transform may represent a transform for vertical components of the target block. The vertical transform kernel and/or the horizontal transform kernel may be adaptively determined based on a prediction mode and/or a transform index of the target block (CU or sub-block) including the residual block.

In addition, according to an example, when a primary transform is performed by applying MTS, a mapping relationship for transform kernels may be established by setting specific basis functions to predetermined values and combining whether certain basis functions are applied in a vertical transform or a horizontal transform. For example, when a horizontal transform kernel is represented as trTypeHor and a vertical transform kernel is represented as trTypeVer, a value 0 of trTypeHor or trTypeVer may be set to DCT2, a value 1 of trTypeHor or trTypeVer may be set to DST7, and a value 2 of trTypeHor or trTypeVer may be set to DCT8.

In this case, MTS index information may be encoded and signaled to a decoding apparatus to indicate one of a plurality of transform kernel sets. For example, when an MTS index is 0, it may indicate that both trTypeHor and trTypeVer values are 0, when the MTS index is 1, it may indicate that both trTypeHor and trTypeVer values are 1, when the MTS index is 2, it may indicate that trTypeHor is 2 and trTypeVer is 1, when the MTS index is 3, it may indicate that trTypeHor is 1 and trTypeVer is 2, and when the MTS index is 4, it may indicate that both trTypeHor and trTypeVer values are 2.

In addition, such MTS may be applied explicitly by signaling as described above, or may be applied implicitly according to specific conditions. In the case of implicit MTS, transform kernels for each direction may be independently derived based on a width or a height of a transform block. According to an example, when a sub-block transform (SBT), in which a transform is applied only to any one of sub-blocks, is applied, implicit MTS may be applied when the width or height satisfies a specific condition or when a condition for a specific intra mode is satisfied. For example, implicit MTS may be applied to a block to which SBT is applied and in which a larger value of the width or height is equal to or less than 32 or 64. Alternatively, implicit MTS may be applied to a block to which ISP is applied, or may be applied to a block to which intra prediction is applied but LFNST and MIP are not applied.

In addition, implicit MTS may infer a primary transform pair based on an intra prediction mode of a current block and a size of a transform unit (TU) by using a lookup table (LUT). For example, the same intra prediction modes as in explicit MTS may be considered, and a maximum TU size may be 32×32. In this case, the LUT may include transform pairs based on a separable primary transform, and an additional primary transform may not be added. For example, DCT2, DCT5, DCT8, DST1, DST4, and DST7 may be used.

For example, in the case of an ISP block, a sizeIdx used as an input to a LUT may be based on a position of a current ISP sub-partition within the ISP block. In addition, according to an example, implicit MTS may be applied only to an ISP block depending on a CTC configuration. According to another example, implicit MTS may be applied to an angular intra prediction mode. For example, implicit MTS for an ISP block may be used by applying implicit signaling to all modes (non-CTC). For example, a default implicit MTS (i.e., based on a shape of a TU) may be maintained in TIMD and DIMD modes. In addition, DCT2 may be used for MIP, EIP, SGPM, and IntraTMP modes. In addition, the default implicit MTS may be used for ISP blocks.

Hereinafter, a method of transform, namely LFNST (Low Frequency Non-Separable Transform), will be described.

Meanwhile, a transformer of an encoding apparatus may perform a secondary transform based on (primary) transform coefficients to derive modified (secondary) transform coefficients. Here, the primary transform refers to a transform from a spatial domain to a frequency domain, and the secondary transform refers to transforming into a more compact representation by using a correlation existing among the (primary) transform coefficients. The secondary transform may include a non-separable transform. In this case, the secondary transform may be referred to as a non-separable secondary transform (NSST). The non-separable secondary transform may represent a transform that generates modified transform coefficients (or secondary transform coefficients) for a residual signal by secondarily transforming the (primary) transform coefficients derived through the primary transform based on a non-separable transform matrix. Here, based on the non-separable transform matrix, the transform may be applied at once without separately (or independently) applying vertical and horizontal transforms to the (primary) transform coefficients. In other words, the non-separable secondary transform may represent a transform method in which vertical and horizontal components of the (primary) transform coefficients are not separated, and for example, two-dimensional signals (transform coefficients) are rearranged into one-dimensional signals in a predetermined direction (e.g., a row-first direction or a column-first direction), and then modified transform coefficients (or secondary transform coefficients) are generated based on the non-separable transform matrix. For example, the row-first order refers to arranging an M×N block in a sequence of a first row, a second row, . . . , and an N-th row, and the column-first order refers to arranging an M×N block in a sequence of a first column, a second column, . . . , and an M-th column. The non-separable secondary transform may be applied to a top-left region of a block composed of the (primary) transform coefficients (hereinafter, referred to as a transform coefficient block). The non-separable secondary transform may select a transform kernel (or transform core, transform type) in a mode-dependent manner. Here, the mode may include an intra prediction mode and/or an inter prediction mode.

The non-separable secondary transform may be performed based on an 8×8 transform or a 4×4 transform determined based on a width (W) and a height (H) of a transform coefficient block. The 8×8 transform refers to a transform that may be applied to an 8×8 region included in the transform coefficient block when both W and H are greater than or equal to 8, and the 8×8 region may be a top-left 8×8 region within the transform coefficient block. Similarly, the 4×4 transform refers to a transform that may be applied to a 4×4 region included in the transform coefficient block when both W and H are greater than or equal to 4, and the 4×4 region may be a top-left 4×4 region within the transform coefficient block. For example, an 8×8 transform kernel matrix may be a 64×64/16×64 matrix, and a 4×4 transform kernel matrix may be a 16×16/8×16 matrix.

Meanwhile, for mode-based transform kernel selection, transform sets for the non-separable secondary transform may be configured, and k non-separable secondary transform kernels may be included in each transform set. For example, the number of transform sets may be 4, 35, or the like. Selection of a specific set among the transform sets may be performed, for example, based on an intra prediction mode of a target block (CU or sub-block).

For example, when it is determined that a specific set is used for a non-separable transform, one of k transform kernels within the specific set may be selected through a non-separable secondary transform index. An encoding apparatus may derive a non-separable secondary transform index indicating a specific transform kernel based on an RD (rate-distortion) check, and may signal the non-separable secondary transform index to a decoding apparatus. The decoding apparatus may select one of the k transform kernels within the specific set based on the non-separable secondary transform index.

An inverse transformer of the encoding apparatus and the decoding apparatus may perform a series of procedures in a reverse order of the procedures performed by the transformer described above. The inverse transformer may receive (dequantized) transform coefficients and perform a secondary (inverse) transform to derive (primary) transform coefficients. The primary transform coefficients may be referred to as modified transform coefficients from the perspective of the inverse transformer.

In the present disclosure, in order to reduce computational complexity and memory requirements associated with a non-separable secondary transform, an RST (reduced secondary transform), in which a size of a transform matrix (kernel) is reduced from the concept of NSST, may be applied. The RST may be referred to by various terms such as reduced transform, reduced secondary transform, reduction transform, simplified transform, simple transform, and the like, and the terminology used to refer to the RST is not limited to the examples listed above. Alternatively, since the RST is mainly performed in a low-frequency region including non-zero coefficients in a transform block, it may also be referred to as LFNST (Low-Frequency Non-Separable Transform).

In LFNST, an N-dimensional vector may be mapped to an R-dimensional vector located in another space, and a reduced transform matrix may be determined, where R is smaller than N. N may represent a square of a length of one side of a block to which a transform is applied or a total number of transform coefficients corresponding to the block to which the transform is applied, and a reduction factor may represent a value of R/N.

According to an example, a size of an LFNST matrix may be R×N, which is smaller than a size N×N of a conventional transform matrix, and may be defined as in Equation 3 below.

$${T}_{R \times N} = [ \begin{matrix}{t}_{11} & {t}_{12} & {t}_{13} & & {t}_{1 N} \\ {t}_{21} & {t}_{22} & {t}_{23} & ⋯ & {t}_{2 N} \\ & ⋮ & & ⋱ & ⋮ \\ {t}_{R 1} & {t}_{R 2} & {t}_{R 3} & ⋯ & {t}_{RN}\end{matrix} ] \qquad [ Equation 3 ]$$

When an LFNST matrix T_{R×N} is multiplied with residual samples of a target block, transform coefficients for the target block may be derived. When a size of a block to which the transform is applied is 8×8 and R=16 (i.e., R/N=16/64=1/4), the LFNST may be represented as a matrix operation as shown in Equation 4 below.

$$[ \begin{matrix}{t}_{1 , 1} & {t}_{1 , 2} & {t}_{1 , 3} & & {t}_{1 , 64} \\ {t}_{2 , 1} & {t}_{2 , 2} & {t}_{2 , 3} & ⋯ & {t}_{2 , 64} \\ & ⋮ & & ⋱ & ⋮ \\ {t}_{16 , 1} & {t}_{16 , 2} & {t}_{16 , 3} & ⋯ & {t}_{16 , 64}\end{matrix} ] \times [ \begin{matrix}{r}_{1} \\ {r}_{2} \\ ⋮ \\ {r}_{64}\end{matrix} ] \qquad [ Equation 4 ]$$

In Equation 4, r1 to r64 may represent residual samples for the target block, and more specifically, may be transform coefficients generated by applying a primary transform. As a result of the operation of Equation 4, transform coefficients ci for the target block may be derived, where ci may include c1 to cR. That is, when R=16, transform coefficients c1 to c16 for the target block may be derived.

If a conventional (regular) transform is applied instead of LFNST, and a transform matrix having a size of 64×64 (N×N) is multiplied with residual samples having a size of 64×1 (N×1), 64 (N) transform coefficients for the target block would be derived. However, since LFNST is applied, only 16 (R) transform coefficients for the target block are derived. Since a total number of transform coefficients for the target block is reduced from N to R, an amount of data transmitted from the encoding apparatus to the decoding apparatus is reduced, thereby improving transmission efficiency between the encoding apparatus and the decoding apparatus.

A size of an inverse LFNST matrix T_{N×R} is N×R, which is smaller than a size N×N of a conventional inverse transform matrix, and has a transpose relationship with the LFNST matrix T_{R×N} shown in Equation 3. Tt may represent an inverse LFNST matrix T_{R×N}^{T} (where the superscript T denotes transpose). When the inverse LFNST matrix T_{R×N}^{T} is multiplied with transform coefficients for the target block, modified transform coefficients for the target block or residual samples for the target block may be derived. The inverse LFNST matrix T_{R×N}^{T} may also be expressed as (T_{R×N})T_{N×R}.

According to an example, when a size of a block to which an inverse transform is applied is 8×8 and R=16 (i.e., R/N=16/64=1/4), the inverse LFNST may be represented as a matrix operation as shown in Equation 5 below.

$$[ \begin{matrix}{t}_{1 , 1} & & {t}_{2 , 1} & & {t}_{16 , 1} \\ {t}_{1 , 2} & & {t}_{2 , 2} & ⋯ & {t}_{16 , 2} \\ {t}_{1 , 3} & & {t}_{2 , 3} & & {t}_{16 , 3} \\ ⋮ & & ⋮ & & ⋮ \\ & ⋮ & & ⋱ & ⋮ \\ {t}_{1 , 16} & & {t}_{2 , 16} & ⋯ & {t}_{16 , 64}\end{matrix} ] \times [ \begin{matrix}{c}_{1} \\ {c}_{2} \\ ⋮ \\ {c}_{16}\end{matrix} ] \qquad [ Equation 5 ]$$

c1 to c16 may represent transform coefficients for the target block. As a result of the operation of Equation 5, rj representing modified transform coefficients for the target block or residual samples for the target block may be derived. rj may include r1 to rN. That is, when N=64, transform coefficients r1 to r64 for the target block may be derived.

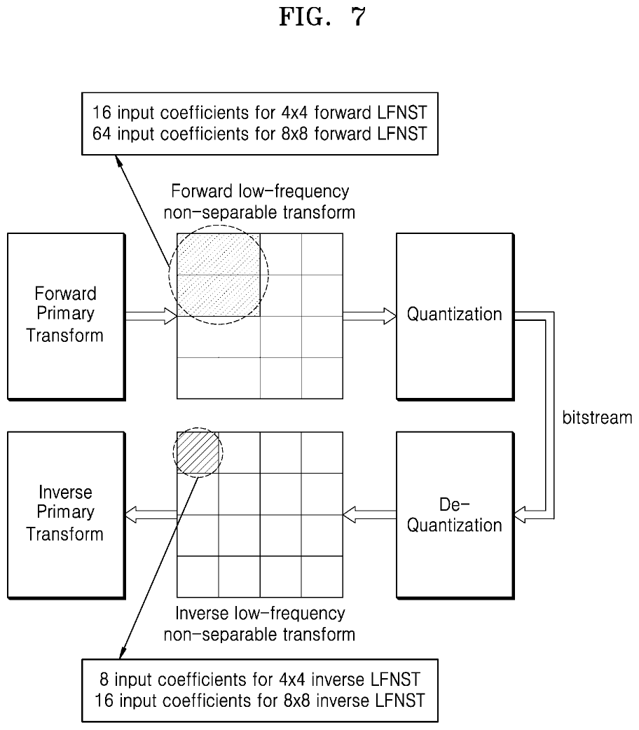

FIG. 7 illustrates an example of LFNST.

Referring to FIG. 7, a 4×4 LFNST may be applied to a block in which min(width, height)<8, and an 8×8 LFNST may be applied to a block in which min(width, height)>4.

For example, 16 (primary) transform coefficients may be input for a 4×4 forward LFNST, and 64 (primary) transform coefficients may be input for an 8×8 forward LFNST. Since 8 or 16 transform coefficients may be derived through such forward LFNST, 8 or 16 transform coefficients may be input for inverse LFNST, respectively. When the 4×4 inverse LFNST is performed, 16 modified transform coefficients may be output from 8 transform coefficients, and when the 8×8 inverse LFNST is performed, 64 modified transform coefficients may be output from 16 transform coefficients.

Meanwhile, according to an example, in a transform of an encoding process, instead of applying a 16×64 transform kernel matrix to 64 data elements constituting an 8×8 region, only 48 data elements may be selected and a transform kernel matrix of up to 16×48 may be applied. Here, “up to” means that, for an m×48 transform kernel matrix capable of generating m coefficients, a maximum value of m is 16. That is, when LFNST is performed by applying an m×48 transform kernel matrix (m≤16) to the 8×8 region, m coefficients may be generated using 48 data elements as input. When m is 16, 16 coefficients are generated from 48 input data elements. That is, when the 48 data elements form a 48×1 vector, a 16×1 vector may be generated by sequentially multiplying a 16×48 matrix and the 48×1 vector. In this case, the 48 data elements constituting the 8×8 region may be appropriately arranged to form the 48×1 vector. When matrix operation is performed by applying the transform kernel matrix of up to 16×48, 16 modified transform coefficients are generated, and the 16 modified transform coefficients may be arranged in a top-left 4×4 region according to a scanning order, and a top-right 4×4 region and a bottom-left 4×4 region may be filled with zeros.

In an inverse transform of a decoding process, a transpose matrix of the transform kernel matrix described above may be used. That is, when inverse LFNST is performed as an inverse transform process performed by a decoding apparatus, input coefficient data to which inverse LFNST is applied may be configured as a one-dimensional vector according to a predetermined arrangement order, and a modified coefficient vector obtained by multiplying the inverse LFNST matrix to the one-dimensional vector from the left may be arranged in a two-dimensional block according to a predetermined arrangement order. In this case, the matrix operation may be represented as (48×16 matrix)×(16×1 transform coefficient vector)=(48×1 modified transform coefficient vector). Here, an n×1 vector may be interpreted as having the same meaning as an n×1 matrix, and thus may be represented as an n×1 column vector. “x” denotes a matrix multiplication operation. When such a matrix operation is performed, 48 modified transform coefficients may be derived, and the 48 modified transform coefficients may be arranged in a top-left region, a top-right region, and a bottom-left region excluding a bottom-right region of the 8×8 area.

Meanwhile, LFNST may be applied to sub-blocks. For example, when a coding block is split into sub-blocks, a size of each sub-block may be “width/2×height/2” or “width/4×height/4”. In this case, the sub-blocks may include sub-blocks located at corners or a sub-block located at a center. For example, LFNST may be applied to sub-blocks located at the corners. In this case, similar to an existing SBT, a split mode and a position of a non-zero sub-block may be signaled.

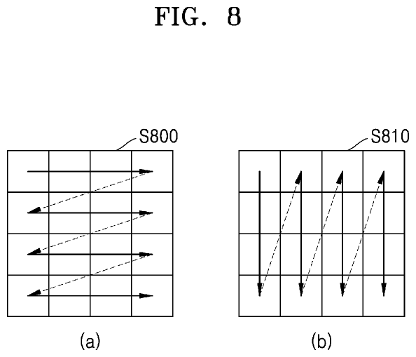

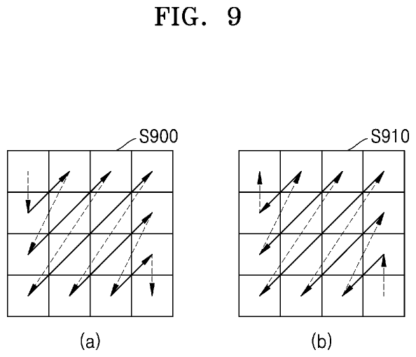

FIG. 8 and FIG. 9 illustrate examples of scan methods of transform coefficients within a block.

Referring to FIG. 8 and FIG. 9, the block illustrated in FIG. 8 and FIG. 9 may be a 4×4 transform block, or a 4×4 sub-block of a 8×8, 16×16, 32×32, or 64×64 transform block. Alternatively, the illustrated block may be a non-square block. In addition, the 4×4 block of FIG. 8 may represent a luma block or a chroma block.

For example, in a 4×4 block, transform coefficients may be scanned according to a scanning order. Referring to FIG. 8(a), scanning of the block (800) may start from a first row and proceed to a second row and a third row, and scanning in each row may be performed in a left-to-right order. In addition, referring to FIG. 8(b), scanning of the block (810) may start from a first column and proceed to a second column and a third column, and scanning in each column may be performed in a top-to-bottom order.

In addition, for example, a scanning method may be determined based on a transform type of the block. For example, when an identity transform is performed in a horizontal direction for the block, scanning for the block may be performed as shown in FIG. 8(a). Specifically, when the transform type of the block is “V_DCT”, “V_ADST”, or “V_FLIPADST”, scanning for the block may be performed as shown in FIG. 8(a). In addition, for example, when an identity transform is performed in a vertical direction for the block, scanning for the block may be performed as shown in FIG. 8(b). Specifically, when the transform type of the block is “H_DCT”, “H_ADST”, or “H_FLIPADST”, scanning for the block may be performed as shown in FIG. 8(b).

Alternatively, for example, when an identity transform is performed in a horizontal direction for the block, scanning for the block may be performed as shown in FIG. 8(b). Specifically, when the transform type of the block is “V_DCT”, “V_ADST”, or “V_FLIPADST”, scanning for the block may be performed as shown in FIG. 8(b). In addition, for example, when an identity transform is performed in a vertical direction for the block, scanning for the block may be performed as shown in FIG. 8(a). Specifically, when the transform type of the block is “H_DCT”, “H_ADST”, or “H_FLIPADST”, scanning for the block may be performed as shown in FIG. 8(a).

In addition, referring to FIG. 9(a) and FIG. 9(b), scanning may be performed in a diagonal direction. Referring to FIG. 9(a), scanning of the block (900) may proceed from a top-right coefficient to a bottom-left coefficient. In addition, referring to FIG. 9(b), scanning of the block (910) may proceed from a bottom-left coefficient to a top-right coefficient.

Hereinafter, a transform process will be described.

An encoding apparatus may perform a transform based on residual samples to derive transform coefficients, and may perform quantization based on the transform coefficients to derive quantized transform coefficients. In addition, a decoding apparatus may perform dequantization based on the quantized transform coefficients to derive transform coefficients, and may perform an inverse transform on the transform coefficients to derive residual samples.

In the (inverse) transform process, a primary transform, a secondary transform, and the like may be used. For example, the transform in the (inverse) transform process may be performed based on a combination of a primary transform, a secondary transform, and the like. In addition, the transform in the (inverse) transform process may be performed by using a separable transform, a non-separable transform, or a combination of a separable transform and a non-separable transform.

The primary transform may be performed based on transform types such as DCT (Discrete Cosine Transform), ADST (Asymmetric Discrete Sine Transform), IDTX (Identity Transform), and WHT (Walsh-Hadamard Transform). In this case, the primary transform may refer to a forward primary transform or an inverse primary transform.

For example, a transform type to be used may be determined based on a size of a block. For example, the DCT transform type may be used when the block size is 4×4, 8×8, 16×16, 32×32, or 64×64, the ADST transform type may be used when the block size is 4×4, 8×8, or 16×16, the IDTX transform type may be used when the block size is 4×4, 8×8, 16×16, or 32×32, and the WHT transform type may be used when the block size is 4×4. In addition, the WHT may be used in the case of lossless coding. For example, when coding is performed using a special 4×4 transform designed to encode a frame identical in bits to an original frame, the WHT transform type may be used.

The secondary transform may include a horizontal primary transform and a vertical primary transform. For example, the secondary transform may be performed based on the horizontal primary transform and the vertical primary transform. In this case, the secondary transform may refer to a forward secondary transform or an inverse secondary transform.

For example, the horizontal primary transform and the vertical primary transform may be performed based on transform types such as DCT, ADST, FLIPADST, and IDTX. In this case, the primary transform may refer to a forward primary transform or an inverse primary transform.

For example, an encoding apparatus may perform a forward secondary transform. The forward secondary transform may perform a transform on columns of a transform block and then perform a transform on rows. For example, a primary transform may be performed on the columns, and based on a result of the primary transform, another primary transform may be performed to derive transform coefficients. In this case, the first performed primary transform may refer to a vertical primary transform, and the second performed primary transform may refer to a horizontal primary transform.

In addition, for example, the vertical primary transform and the horizontal primary transform may be performed based on transform types such as “DCT_DCT”, “ADST_DCT”, “DCT_ADST”, “ADST_ADST”, “FLIPADST_DCT”, “DCT_FLIPADST”, “FLIPADST_FLIPADST”, “ADST_FLIPADST”, “FLIPADST_ADST”, “IDTX”, “V_DCT”, “H_DCT”, “V_ADST”, “H_ADST”, “V_FLIPADST”, and “H_ADST”.

For example, a decoding apparatus may perform an inverse secondary transform. The inverse secondary transform may perform a transform on rows of a transform block and then perform a transform on columns. For example, a primary transform may be performed on the rows, and based on a result of the primary transform, another primary transform may be performed to derive residual samples. In this case, the first performed primary transform may refer to a horizontal primary transform, and the second performed primary transform may refer to a vertical primary transform.

In addition, for example, the horizontal primary transform and the vertical primary transform may be performed based on transform types such as “DCT_DCT”, “ADST_DCT”, “DCT_ADST”, “ADST_ADST”, “FLIPADST_DCT”, “DCT_FLIPADST”, “FLIPADST_FLIPADST”, “ADST_FLIPADST”, “FLIPADST_ADST”, “IDTX”, “V_DCT”, “H_DCT”, “V_ADST”, “H_ADST”, “V_FLIPADST”, and “H_ADST”.

An encoding apparatus may output residual information in a form of a bitstream and signal the same to a decoding apparatus. In this case, the residual information is information for deriving residual samples, and may include information on quantized transform coefficients for the residual samples.

A decoding apparatus may output values of syntax elements required for image reconstruction and quantized values of transform coefficients related to residuals. Specifically, the decoding apparatus may output transform coefficients by dequantizing the quantized transform coefficients. In this case, the quantized transform coefficients may be rearranged in a form of a two-dimensional block. In this case, the rearrangement may be performed based on a coefficient scanning order performed in the encoding apparatus. In addition, dequantization may be performed on the quantized transform coefficients using a quantization parameter to obtain transform coefficients. Thereafter, the transform coefficients may be inverse-transformed to obtain a residual signal (a residual block or a residual sample array).

For example, residual information signaled for deriving transform coefficients may be signaled as shown in the table below.

TABLE 7

| | Type |
|---|---|
| coeffs( plane, startX, startY, txSz ) { | |
| x4 = startX >> 2 | |
| y4 = startY >> 2 | |
| [symbol] 4 = Tx_Width[ [symbol] ] >> 2 | |
| [symbol] 4 = Tx_Height[ [symbol] ] >> 2 | |
| txSz [symbol] = ( Tx_Size_ [symbol] [ [symbol] ] + Tx_Size_S [symbol] _ [symbol] p[txSz] + 1 ) >> 1 | |
| ptype = pla [symbol] e > 0 | |
| [symbol] = ( txS [symbol] TX_ [symbol] txSz [symbol] TX_ [symbol] ? 512 [symbol] | |
| [symbol] ( 1024 [symbol] Tx_Width[ txSz ] [symbol] Tx_Height[ txSz ] ) | |
| for ( [symbol] = 0 [symbol] ++ ) | |
| [symbol] [ [symbol] ] = 0 | |
| for ( [symbol] = 0 [symbol] < 64 [symbol] ++ ) | |
| for ( j = 0 [symbol] < 64 [symbol] j++ ) | |
| [symbol] [ i ][ j ] = 0 | |
| [symbol] = 0 | |
| [symbol] Level = 0 | |
| [symbol] Category = 0 | |
| all_zero | S( ) |
| if ( all_zero ) { | |
| [symbol] = 0 | |
| if ( plane == 0 ) { | |
| for ( i = 0 [symbol] i < [symbol] i++ ) { | |
| for ( j = 0 [symbol] j < [symbol] j++ ) { | |
| TxTypes[ y4 + j ][ x4 + i ] = DCT_DCT | |
| } | |
| } | |
| } | |
| } else { | |
| if ( plane == 0 ) | |
| transform_type( x4, y4, txSz ) | |
| PlaneTxType = compute_tx_type( plane, txSz, x4, y4 ) | |
| scan = get_scan( txSz ) | |
| [symbol] Multisize = Min( Tx_Width_Log2[ txSz ] [symbol] ) [symbol] | |
| Min( Tx_Height_Log2[ txSz ] [symbol] ) − 4 | |
| if ( [symbol] Multisize == 0 ) { | |
| [symbol] _pt_16 | S( ) |
| [symbol] = [symbol] _pt_16 + 1 | |
| } else if ( [symbol] Multisize == 1 ) { | |
| [symbol] _pt_32 | S( ) |
| [symbol] Pt = [symbol] _pt_32 + 1 | |
| } else if ( [symbol] Multisize == 2 ) { | |
| [symbol] _pt_64 | S( ) |
| [symbol] Pt = [symbol] _pt_64 + 1 | |
| } else if ( [symbol] Multisize == 3 ) { | |
| [symbol] _pt_128 | S( ) |
| [symbol] Pt = [symbol] _pt_128 + 1 | |
| } else if ( [symbol] Multisize == 4 ) { | |
| [symbol] _pt_256 | S( ) |
| [symbol] Pt = [symbol] _pt_256 + 1 | |
| } else if ( [symbol] Multisize == 5 ) { | |
| [symbol] _pt_512 | S( ) |
| [symbol] Pt = [symbol] _pt_512 + 1 | |
| } else { | |
| [symbol] _pt_1024 | S( ) |
| [symbol] Pt = [symbol] _pt_1024 + 1 | |
| } | |
| [symbol] = ( [symbol] pT < 2 ) ? [symbol] Pt [symbol] ( ( 1 << ( [symbol] pT [symbol] 2 ) ) + 1 ) | |
| [symbol] Shift = Max( −1 [symbol] pT [symbol] ) | |
| if ( [symbol] Shift >= 0 ) { | |
| [symbol] _ [symbol] tr | S( ) |
| if ( [symbol] extra ) { | |
| [symbol] = ( 1 << [symbol] Shift ) | |
| } | |
| for ( 1 [symbol] < [symbol] ) [symbol] ) { | |
| [symbol] Shift = Max( 0 [symbol] ) [symbol] | |
| [symbol] _extra_bit | [symbol] ( [symbol] ) |
| if ( [symbol] _extra_bit ) { | |
| [symbol] ( 1 << [symbol] Shift ) | |
| } | |
| } | |
| } | |
| for ( [symbol] ) { | |
| [symbol] = scan[ [symbol] ] | |
| if ( [symbol] ( eob − 1 ) ) { | |
| coeff_base_eob | S( ) |
| level = coeff_base_ [symbol] + 1 | |
| } else { | |
| coeff_base | S( ) |
| level = [symbol] _base | |
| } | |
| if ( level > NUM_BASE_LEVELS ) { | |
| for ( idx = 0 [symbol] | |
| idx [symbol] COEFF_BASE_RANGE / (BR_ [symbol] _SIZE [symbol] 1 ) [symbol] | |
| idx++ ) { | |
| coeff_br | S( ) |
| level [symbol] coeff_br | |
| if ( coeff_br [symbol] ( BR_ [symbol] _SIZE − 1 ) ) | |
| break | |
| } | |
| } | |
| [symbol] nt[ [symbol] ] = level | |
| } | |
| for ( [symbol] = 0 [symbol] < [symbol] ++ ) { | |
| pos = scan[ [symbol] ] | |
| if ( [symbol] ant[ pos ] [symbol] 0 ) { | |
| if ( [symbol] 0 ) { | |
| d [symbol] sign | S( ) |
| sign = d [symbol] _sign | |
| } else { | |
| sign_bit | [symbol] ( [symbol] ) |
| sign = sign_bit | |
| } | |
| } else { | |
| sign = 0 | |
| } | |
| if ( Quant[ [symbol] ] [symbol] | |
| ( NUM_BASE_LEVELS [symbol] COEFF_BASE_RANGE ) ) { | |
| length = 0 | |
| d [symbol] | |
| length++ | |
| [symbol] _length_bit | [symbol] ( [symbol] ) |
| [symbol] while ( [symbol] length_bit ) | |
| [symbol] = 1 | |
| for ( [symbol] length − 2 [symbol] >= [symbol] ) { | |
| [symbol] _data_bit | [symbol] ( [symbol] ) |
| [symbol] ( x [symbol] ) [symbol] data_bit | |
| } | |
| [symbol] [pos ] = x [symbol] COEFF_BASE_RANGE [symbol] NUM_BASE_LEVELS | |
| } | |
| if ( pos [symbol] && Quant[ pos ] [symbol] 0 ) { | |
| [symbol] Category = sign ? [symbol] | |
| } | |
| Quant[ pos ] = Quant[ pos ] [symbol] | |
| [symbol] Level [symbol] Quant[ pos ] | |
| if ( sign ) | |
| Quant[ pos ] [symbol] Quant[ pos ] | |
| } | |
| [symbol] Level = Min ( [symbol] Level ) | |
| } | |
| for ( [symbol] = [symbol] ++ ) { | |
| [symbol] Level [symbol] plane [symbol] x4 [symbol] = [symbol] evel | |
| [symbol] Context [symbol] plane [symbol] x4 [symbol] Category | |
| } | |
| for ( [symbol] ++ ) { | |
| [symbol] Level [symbol] plane [symbol] 4 [symbol] = [symbol] Level | |
| [symbol] Context [symbol] plane [symbol] 4 [symbol] Category | |
| } | |
| return [symbol] | |
| } | |

[symbol]

indicates data missing or illegible when filed

For example, “tx_types” may be information indicating an array storing transform types to be used at a 4×4 luma sample granularity. In this case, the transform type may be read only for a luma transform block, and a chroma block may use a transform type of a corresponding luma block.

In addition, “Quant” may be an array storing quantized coefficients for a current transform block, and “all_zero” may be information indicating whether all coefficients of the current transform block are zero.

In addition, “eob” is an abbreviation of “end of block” and may represent a value obtained by adding 1 to an index of a last non-zero coefficient in the transform block. That is, “eob” may represent a position of the last non-zero coefficient in a scan order. For example, “eob−1” may represent a position of the last non-zero coefficient.

In addition, “eob_pt_xx” may indicate an index of an eob group in which the last non-zero coefficient is located within the transform block. For example, a value of “eobpt_xx”+1 may correspond to an index value of the eob group in which the last non-zero coefficient is located based on a scan order.

In addition, “eob_extra” and “eob_extra_bit” may be information used to calculate the variable eob and to specify a position of the last non-zero coefficient. That is, the variable eob may be derived in the eob group based on “eob_extra” and “eob_extra_bit”.

In addition, “coeff_base” may be information indicating a base level of a coefficient. In this case, “coeff_base” may be used for all coefficients except for the last non-zero coefficient. For example, “coeff_base” may indicate one of values 0 to 3 as a base value of a target coefficient.

In addition, “coeff_base_eob” may be information used to calculate a base level of the last non-zero coefficient. For example, since an eob value may not be 0, “coeff_base_eob” may indicate one of values 1 to 3 as an eob base value.

In addition, “coeff_br” may be information indicating an increment of a coefficient. For example, “coeff_br” may be signaled up to four times, and signaling of “coeff_br” may be stopped when a value of “coeff_br” is not equal to 3. For example, to represent a level value of 5, “coeff_base=3” and “coeff_br=2” may be signaled. For example, to represent a level value of 6, “coeff_base=3”, “coeff_br=3”, and “coeff_br=0” may be signaled.

For example, when the level value is 0 to 3, the level value may be represented only by “coeff_base”. In addition, when the level value is 3 to 5, the level value may be represented by “coeff_base” and “coeff_br” with idx=0. In addition, when the level value is 6 to 8, the level value may be represented by “coeff_base”, “coeff_br” with idx=0, and “coeff_br” with idx=1. In addition, when the level value is 9 to 11, the level value may be represented by “coeff_base”, “coeff_br” with idx=0, “coeff_br” with idx=1, and “coeff_br” with idx=2. In addition, when the level value is 12 to 15, the level value may be represented by “coeff_base”, “coeff_br” with idx=0, “coeff_br” with idx=1, “coeff_br” with idx=2, and “coeff_br” with idx=3. In addition, since “coeff_br” may be signaled up to four times, additional information may be required when the level value is 15 or greater.

In addition, “dc_sign” may be information indicating a sign of a DC coefficient, and “sign_bit” may be information indicating a sign of a non-zero AC coefficient. For example, after expressing an absolute value level up to 15 for each coefficient in an order from eob to DC, a sign for each coefficient may be signaled in an order from DC to eob.

In addition, “golomb_length_bit” may be information used to calculate a number of additional bits required to code a coefficient, and “golomb_data_bit” may be information indicating a value of one of the additional bits. For example, when a level of a coefficient is 15 or greater, “golomb_length_bit” and “golomb_data_bit” may be used. For example, when the level of the coefficient is 16, “01” may be used as “golomb_length_bit”, and “0” may be used as “golomb_data_bit”.

The (inverse) transform for the current block may be performed based on a 1D transform, a 2D transform, or an identity transform.

The (inverse) transform may be performed based on different transform sets or transform types according to a size of a block and a prediction mode. In addition, information on a transform type applied to the (inverse) transform may be signaled as shown in the table below.

TABLE 8

| | Type |
|---|---|
| transform_type( x4, y4, txSz ) { | |
| set = get_tx_set ( txSz ) | |
| if ( set > 0 [symbol] | |
| ( segmentation_enabled ? get_qindex( [symbol] segment_id ) [symbol] | |
| base_q_idx ) > 0 ) [symbol] | |
| if ( [symbol] _inter ) { | |
| inter_tx_type | S( ) |
| if ( set [symbol] TX_SET_INTER_ [symbol] ) | |
| TxType = Tx_Type_Inter_Inv_Set [symbol] [ inter_tx_type ] | |
| else if ( set [symbol] TX_SET_INTER_2 ) | |
| TxType = Tx_Type_Inter_Inv_Set2[ inter_tx_type ] | |
| else | |
| TxType = Tx_Type_Inter_Inv_Set3[ inter_tx_type ] | |
| } else { | |
| intra_tx_type | S( ) |
| if ( set [symbol] TX_SET_INTRA [symbol] ) | |
| TXType = Tx_Type_Intra_Inv_Set1[ intra_tx_type ] | |
| else | |
| TXType = Tx_Type_Intra_Inv_Set2[ intra_tx_type ] | |
| } | |
| } else { | |
| TxType [symbol] DCT_DCT | |
| } | |
| for ( [symbol] ( Tx_Width[ txSz ] [symbol] 2 ) [symbol] i++ ) { | |
| for ( [symbol] ( Tx_Height[ txSz ] [symbol] 2 ) [symbol] j++ ) { | |
| TxType[ [symbol] ][ [symbol] ] = TxType | |
| } | |
| } | |
| } | |

[symbol]

indicates data missing or illegible when filed

In addition, for example, information on a transform set applied to the (inverse) transform may be signaled as shown in the table below.

TABLE 9

Type

```

[symbol]
et_tx_set [symbol] txSz [symbol]
  txSzSqr = Tx_Size_Sqr[ txSz ]
  txSzSqrUp = Tx_Size_Sqr_Up[ txSz ]
  if [symbol] txSzSqrUp > TX_32X [symbol]
      return TX_SET_ [symbol] ONLY
  if ( is_inter ) {
    if ( reduced_tx_set || txSzSqrUp == TX_32X32 ) return
        TX_SET_INTER_ [symbol]
      else if ( txSzSqr == TX_1 [symbol] X1 [symbol] ) return TX_SET_INTER_2
      return TX_SET_INTER_1
  } else {
      if ( txSzSqrUp == TX_32X32 ) return TX_SET_DCTONLY
      else if ( reduced_tx_set ) return TX_SET_INTRA_2
      else if ( txSzSqr == TX_16X16 ) return TX_SET_INTRA_2
      return TX_SET_INTRA_1
  }
} [symbol]
indicates data missing or illegible when filed
```

For example, the (inverse) transform may be performed based on different transform sets or transform types according to a size of a block and a prediction mode. For example, the transform set applied to the inverse transform may be determined based on whether the prediction mode of the block is an intra prediction mode or an inter prediction mode. In addition, the transform type applied to the inverse transform may be determined based on the prediction mode of the block and the size of the block. In addition, the transform set applied to the inverse transform may be determined based on whether the size of the block is 16×16 or 32×32. In addition, the transform set applied to the inverse transform may be determined based on whether the prediction mode is an intra prediction mode or an inter prediction mode. In this case, in the table, “inter_tx_type” may indicate information on a transform type of an inter block, and “intra_tx_type” may indicate information on a transform type of an intra block.

In addition, the transform set may be configured as shown in the table below.

TABLE 10

| is_inter | set | Name of transform set |
|---|---|---|
| Don't care | 0 | TX_SET_DCTONLY |
| 0 | 1 | TX_SET_INTRA_1 |
| 0 | 2 | TX_SET_INTRA_2 |
| 1 | 1 | TX_SET_INTER_1 |
| 1 | 2 | TX_SET_INTER_2 |
| 1 | 3 | TX_SET_INTER_3 |

In the table, “is_inter” may indicate whether a current block is an intra block. For example, when a value of “is_inter” is 0, the current block may be an intra block, and when the value of “is_inter” is 1, the current block may be an inter block.

In addition, the transform set may determine a subset of transform types that may be used for the transform as shown in the table below.

TABLE 11

| | TX_SET_{—} | TX_SET_{—} | TX_SET_{—} | TX_SET_{—} | TX_SET_{—} | TX_SET_{—} |
|---|---|---|---|---|---|---|
| Transform type | DCTONLY | INTRA_1 | INTRA_2 | INTER_1 | INTER_2 | INTER_3 |
| DCT_DCT | X | X | X | X | X | X |
| [symbol] _DCT | | X | X | X | X | |
| DCT_ [symbol] ST | | X | X | X | X | |
| [symbol] ST_ [symbol] ST | | X | X | X | X | |
| FLI [symbol] _DCT | | | | X | X | |
| DCT_FL [symbol] | | | | X | X | |
| FLI [symbol] _FLI [symbol] | | | | X | X | |
| [symbol] ST_FLI [symbol] | | | | X | X | |
| FLI [symbol] _ST | | | | X | X | |
| IDTX | | X | X | X | X | X |
| [symbol] _DCT | | XX | | X | X | |
| [symbol] _DCT | | | | X | X | |
| V_ [symbol] ST | | | | X | | |
| [symbol] _ [symbol] ST | | | | X | | |
| [symbol] _ [symbol] ST | | | | X | | |
| [symbol] _ [symbol] | | | | X | | |

[symbol]

indicates data missing or illegible when filed

For example, the transform types in Table 11 may be applied to a luma component block.

Referring to Table 11, a transform set of a transform block may be one of “TX_SET_DCTONLY”, “TX_SET_TINTRA_1”, “TX_SET_TINTRA_2”, “TX_SET_INTER_1”, “TX_SET_INTER_2”, and “TX_SET_INTER_3”.

For example, for an inter block, when one of a width or a height of the transform block is greater than 32, the transform set of the transform block may be determined as “TX_SET_DCTONLY”. In addition, when a larger value of the width or height of the transform block is 32 or the width or height is 32, the transform set of the transform block may be determined as “TX_SET_INTER_3”. In addition, when a smaller value of the width or height of the transform block is 16 or the width or height is 16, the transform set of the transform block may be determined as “TX_SET_INTER_2”. In other cases, the transform set of the transform block may be determined as “TX_SET_INTER_1”. Meanwhile, one of n transform types may be selected for the transform set of the inter block, and n is a positive integer. Specifically, n may be 3, 4, 5, 6, 7, 8, or the like.

In addition, for example, for an intra block, when one of a width or a height of the transform block is greater than 32, the transform set of the transform block may be determined as “TX_SET_DCTONLY”. In addition, when a larger value of the width or height of the transform block is 32 or the width or height is 32, the transform set of the transform block may be determined as “TX_SET_DCTONLY”. In addition, when a smaller value of the width or height of the transform block is 16 or the width or height is 16, the transform set of the transform block may be determined as “TX_SET_INTRA_2”. In other cases, the transform set of the transform block may be determined as “TX_SET_INTER_1”. Meanwhile, one of n transform types may be selected for the transform set of the intra block, and n is a positive integer. Specifically, n may be 3, 4, 5, 6, 7, 8, or the like.

In addition, referring to Table 11, the transform type may be one of “DCT_DCT”, “ADST_DCT”, “DCT_ADST”, “ADST_ADST”, “FLIPADST_DCT”, “DCT_FLIPADST”, “FLIPADST_FLIPADST”, “ADST_FLIPADST”, “FLIPADST_ADST”, “IDTX”, “V_DCT”, “H_DCT”, “V_ADST”, “H_ADST”, “V_FLIPADST”, and “H_ADST”.

A transform kernel corresponding to the transform type may be as shown in the table below.

TABLE 12

| | Vertical direction | Horizontal direction |
|---|---|---|
| Transform type | transform | transform |
| DCT_DCT | DCT | DCT |
| ADST_DCT | ADST | DCT |
| DCT_ADST | DCT | ADST |
| ADST_ADST | ADST | ADST |
| FLIPADST_DCT | FLIPADST | DCT |
| DCT_FLIPADST | DCT | FLIPADST |
| FLIPADST_FLIPADST | FLIPADST | FLIPADST |
| ADST_FLIPADST | ADST | FLIPADST |
| FLIPADST_ADST | FLIPADST | ADST |
| IDTX | IDTX | IDTX |
| V_DCT | DCT | IDTX |
| H_DCT | IDTX | DCT |
| V_ADST | ADST | IDTX |
| H_ADST | IDTX | ADST |
| V_FLIPADST | FLIPADST | IDTX |
| H_FLIPADST | IDTX | FLIPADST |

For example, in the case of the transform type “DCT_DCT”, a “DCT” transform may be performed in both a vertical direction and a horizontal direction. In addition, in the case of the transform type “ADST_DCT”, an “ADST” transform may be performed in the vertical direction and a “DCT” transform may be performed in the horizontal direction. That is, the former transform may represent a transform in the vertical direction, and the latter transform may represent a transform in the horizontal direction. In addition, the transform type “IDTX” may represent an identity transform. In addition, the transform type “FLIPADST” may represent a flipped “ADST”.

In addition, the transform type may be determined according to an intra prediction mode. The table below shows transform types applicable to a chroma component block.

TABLE 13

| | Vertical | Horizontal | Intra |
|---|---|---|---|
| Transform | direction | direction | prediction |
| type | transform | transform | mode |
| DCT_DCT | DCT | DCT | DC_PRED |
| ADST_DCT | ADST | DCT | V_PRED |
| DCT_ADST | DCT | ADST | H_PRED |
| ADST_ADST | ADST | ADST | D45_PRED |
| ADST_DCT | ADST | DCT | D135_PRED |
| DCT_ADST | DCT | ADST | D113_PRED |
| DCT_ADST | DCT | ADST | D157_PRED |
| ADST_DCT | ADST | DCT | D203_PRED |
| ADST_ADST | ADST | ADST | D67_PRED |
| ADST_DCT | ADST | DCT | SMOOTH_PRED |
| DCT_ADST | DCT | ADST | SMOOTH_V_PRED |
| ADST_ADST | ADST | ADST | PAETH_RED_PRED |
| DCT_DCT | DCT | DCT | UV_CFL_PRED |

Referring to Table 13, a transform type for a chroma component block may be determined based on an intra prediction mode.

For example, when an intra prediction mode of a chroma block is a DC prediction mode, a transform type of a transform block may be determined as “DCT_DCT”. In addition, when the intra prediction mode of the chroma block is a vertical prediction mode, the transform type of the transform block may be determined as “ADST_DCT”. In this case, as described above, the former transform may represent a transform in a vertical direction, and the latter transform may represent a transform in a horizontal direction.

In addition, when a prediction mode of the chroma block is an inter prediction mode, a transform type for the chroma block may be determined based on a transform type of a corresponding luma block. Accordingly, the transform type for the chroma block may not be explicitly signaled through a bitstream.

Hereinafter, parity hiding will be described.

According to the present disclosure, when signaling parity for quantized transform coefficients, parity of a specific quantized transform coefficient may be hidden. This may be referred to as a parity hiding method.

For example, an encoding apparatus may signal information indicating parity of transform coefficients, and a decoding apparatus may acquire the information indicating the parity of the transform coefficients through a bitstream and derive the parity of the transform coefficients. In this case, the information indicating the parity of the transform coefficients may be signaled for all transform coefficients, or may be signaled only for transform coefficients except for a specific transform coefficient. That is, the information indicating the parity of the transform coefficients may be selectively signaled.

In addition, flag information indicating whether the parity hiding is applied may be signaled. For example, whether the parity hiding is applied to a current block may be determined based on the flag information indicating whether the parity hiding is applied. In this case, the current block may be a transform block. In addition, the current block may be sub-blocks of the transform block. That is, the flag information may be signaled for the transform block or may be signaled for sub-blocks of the transform block.

For example, when a value of the flag information indicating whether the parity hiding is applied is 0, it may indicate that the parity hiding is not applied, and when the value of the flag information indicating whether the parity hiding is applied is 1, it may indicate that the parity hiding is applied.

In addition, the flag information indicating whether the parity hiding is applied may be signaled through a sequence header, a tile header, or a frame header. For example, the flag information indicating whether the parity hiding is applied may be signaled through one of a sequence header, a tile header, and a frame header.

In addition, first flag information indicating whether parity hiding is applied at a higher level may be signaled, and second flag information indicating whether parity hiding is applied may be signaled based on the first flag information.

For example, the first flag information may be signaled in the sequence header, and the second flag information may be signaled in the tile header or the frame header based on the first flag information. In addition, the first flag information may be signaled in the tile header, and the second flag information may be signaled in the frame header based on the first flag information.

In addition, information indicating parity of a transform coefficient may be signaled. For example, the information indicating the parity of the transform coefficient may indicate parity of a level of the transform coefficient, and may indicate whether the level value is even or odd. For example, an odd level value may be represented as “0”, and an even level value may be represented as “0”. Alternatively, an odd level value may be represented as “0”, and an even level value may be represented as “1”.

For example, the information indicating the parity of the transform coefficient may be represented by a syntax element “coeff_parity”.

In this case, the information indicating the parity of the transform coefficient may be signaled before “eob_pt_xx”, which is information indicating an index of an eob group in which a last non-zero coefficient is located within a transform block, as shown in the table below.

```
TABLE 14
...
  all_zero
  if (all_zero) {
  ...
  } else {
    ...
    coeff_parity
    ... [symbol]
    = Min(Tx_Width_Log2 [symbol] txSz [symbol] + [symbol] Tx_Height_Log2 [symbol] txSz [symbol]
    if( [symbol] == 0 ) {
      eob_pt_16
      ...
      eob_pt_32
      ...
      eob_pt_64
      ...
      eob_pt_128
      ...
      eob_pt_256
      ...
      eob_pt_512
      ...
      eob_pt_1024
      ...
  }
... [symbol]
indicates data missing or illegible when filed
```

Alternatively, “coeff_parity” may be signaled after “eob_pt_xx”, which is information indicating an index of an eob group in which a last non-zero coefficient is located within a transform block, as shown in the table below.

```
TABLE 15
...
  all_zero
  if (all_zero) {
  ...
  } else {
    ... [symbol]
    = Min(Tx_Width_Log2 [symbol] txSz [symbol] + [symbol] Tx_Height_Log2 [symbol] txSz [symbol]
    if( [symbol] == 0 ) {
      eob_pt_16
      ...
      eob_pt_32
      ...
      eob_pt_64
      ...
      eob_pt_128
      ...
      eob_pt_256
      ...
      eob_pt_512
      ...
      eob_pt_1024
      ...
    }
    ...
    coeff_parity
  }
... [symbol]
indicates data missing or illegible when filed
```

In addition, “coeff_parity” may be signaled before “eob_extra” and “eob_extra_bit”, which are information used to calculate the variable eob and indicate a position of a last non-zero coefficient, as shown in the table below.

TABLE 16

```
...
  all_zero
  if (all_zero) {
  ...
  } else {
    ...
    coeff_parity
    ...
    eob = ( eobPt < 2 ) ? eobPt : (( 1 << ( eobPt − 2 )) + 1 )
    eobShift = Max( [symbol] eobPt [symbol] 3 )
    if ( [symbol] Shift >= 0 ) {
      eob_extra
      ...
        eob_extra_bit
      ...
    }
  }
... [symbol]
indicates data missing or illegible when filed
```

In addition, “coeff_parity” may be signaled after “eob_extra” and “eob_extra_bit”, which are information used to calculate the variable eob and indicate a position of a last non-zero coefficient, as shown in the table below.

TABLE 17

```
...
  all_zero
  if (all_zero) {
  ...
  } else {
    ...
    eob = ( eobPt < 2 ) ? eobPt : (( 1 << ( eobPt − 2 )) + 1 )
    eob [symbol] hift = Max( −1, eobPt − [symbol] )
    if ( eob [symbol] hift >= 0 ) {
      eob_extra
      ...
        eob_extra_bit
      ...
    }
    ...
    coeff_parity
  }
... [symbol]
indicates data missing or illegible when filed
```

In addition, “coeff_parity” may be signaled before “coeff_base_eob” and “coeff_base”, which are information used to calculate a base level of a transform coefficient, as shown in the table below.

TABLE 18

```
...
  all_zero
  if (all_zero) {
  ...
  } else {
    ...
    for ( c = eob − 1 [symbol] c >= 0 [symbol] c−− ) {
      pos = scan[ c ]
      coeff_parity
      if ( c == ( eob − 1 )) {
        coeff_base_eob
        level = coeff_base_eob + 1
      } else {
        coeff_base
        level = coeff_base
      }
      ...
      Quant[ pos ] = level
    }
  }
... [symbol]
indicates data missing or illegible when filed
```

Referring to Table 18, c may represent a position of a coefficient in a scan order. For example, when c=eob−1, it may indicate a position of a last non-zero coefficient in the scan order, and when c=0, it may indicate a coefficient at a first position in the scan order.

Alternatively, “coeff_parity” may be signaled after “coeff_base_eob” and “coeff_base”, which are information used to calculate a base level of a transform coefficient, as shown in the table below.

TABLE 19

```
...
  all_zero
  if (all_zero) {
  ...
  } else {
    ...
    for ( c = eob − 1 [symbol] c >= 0 [symbol] c−− ) {
      pos = scan[ c ]
      if ( c == ( eob − 1 )) {
        coeff_base_eob
        level = coeff_base_eob + 1
      } else {
        coeff_base
        level = coeff_base
      }
      coeff_parity
      ...
      Quant[ pos ] = level
    }
  }
... [symbol]
indicates data missing or illegible when filed
```

In addition, “coeff_parity” may be signaled before “coeff_br”, which is information indicating an increment of a coefficient, as shown in the table below.

```
TABLE 20
...
  all_zero
  if (all_zero) {
  ...
  } else {
    ...
    for ( c = eob − 1 [symbol] c >= 0 [symbol] c−− ) {
      pos = scan[ c ]
      if ( c == ( eob − 1 )) {
        coeff_base_eob
        level = coeff_base_eob + 1
      } else {
        coeff_base
        level = coeff_base
      }
      coeff_parity
      if ( level > NUM_BASE_LEVELS ) {
        for ( idx = [symbol] ( c == ( eob − 1 )) {
            idx < COEFF_BASE_RANGE / ( BR_CDF_SIZE − 1);
            idx++ ) {
          coeff_br
          ...
      }
      ...
      Quant[ pos ] = level
    }
  }
... [symbol]
indicates data missing or illegible when filed
```

Referring to Table 20, “coeff_parity” may be signaled after “coeff_base_eob” and “coeff_base” are signaled, and “coeff_br” may be signaled after “coeff_parity” is signaled.

In addition, “coeff_parity” may be signaled after “coeff_br”, which is information indicating an increment of a coefficient, as shown in the table below.

```
TABLE 21
...
  all_zero
  if (all_zero) {
  ...
  } else {
    ...
    for ( c = eob − 1 [symbol] c >= 0 [symbol] c−− ) {
      coeff_base_eob
      level = coeff_base_eob + 1
      } else {
      coeff_base
        level = coeff_base
      }
      if ( level > NUM_BASE_LEVELS ) {
        for ( idx = [symbol] ( c == ( eob − 1 )) {
            idx < COEFF_BASE_RANGE / ( BR_CDF_SIZE − 1 );
            idx++ ) {
          coeff_br
          ...
          coeff_parity
      }
      ...
      Quant[ pos ] = level
    }
  }
... [symbol]
indicates data missing or illegible when filed
```

Referring to Table 21, “coeff_br” may be signaled after “coeff_base_eob” and “coeff_base” are signaled, and “coeff_parity” may be signaled after “coeff_br” is signaled.

For example, “coeff_parity” may be signaled based on whether parity hiding is applied and/or a position of the transform coefficient. For example, the information indicating the parity of the transform coefficient may be signaled as shown in the table below.

TABLE 22

```
...
  ...
  for ( c = eob − 1 [symbol] c >= 0 [symbol] c −− ) {
    pos = scan[ c ]
    ...
    if ( !parity_hiding || ( c != eob − 1 )) {
      coeff_parity
    }
  ...
  }
... [symbol]
indicates data missing or illegible when filed
```

Referring to Table 22, “coeff_parity” may be signaled based on the flag information indicating whether parity hiding is applied. In this case, the flag information indicating whether parity hiding is applied may be flag information signaled through one of a sequence header, a tile header, or a frame header, indicating whether parity hiding is applied. Alternatively, it may be one of the above-described first flag information or second flag information indicating whether parity hiding is applied.

For example, when a value of “parity hiding” is 0, “coeff_parity” may be signaled. Specifically, when parity hiding is not applied, information indicating parity of transform coefficients may be signaled.

In addition, “coeff_parity” may be signaled based on a position of a transform coefficient. Here, c may represent a position of the transform coefficient in a scan order. For example, when c=eob−1, it may indicate a position of a last non-zero coefficient in the scan order. That is, when c eob−1, it may indicate that the position of the transform coefficient is not the position of the last non-zero coefficient. Accordingly, when a value of “parity hiding” is 0 or when the position of the transform coefficient is not the position of the last non-zero coefficient, “coeff_parity” may be signaled. That is, for transform coefficients whose positions are not eob−1, “coeff_parity” may be signaled when the value of “parity hiding” is 0.

In addition, for example, when the value of “parity hiding” is 1, “coeff_parity” may be signaled depending on the position of the transform coefficient. For example, when the value of “parity_hiding” is 1, “coeff_parity” may be signaled for transform coefficients whose positions are not the position of the last non-zero coefficient. That is, “coeff_parity” may not be signaled for the last non-zero coefficient.

In addition, “coeff_parity” may be signaled as shown in the table below.

TABLE 23

```
...
  ...
  for ( c = eob − 1 [symbol] c >= 0 [symbol] c −− ) {
    pos = scan[ c ]
    ...
    if ( !parity_hiding || ( c != 0 )) {
      coeff_parity
    }
  ...
  }
... [symbol]
indicates data missing or illegible when filed
```

Referring to Table 23, “coeff_parity” may be signaled based on “parity_hiding” and a position of a transform coefficient. For example, when c=0, it may indicate a position of a first coefficient in a scan order. That is, when c≠0, it may indicate that the position of the transform coefficient is not the position of the first coefficient. Accordingly, when a value of “parity_hiding” is 0 or when the position of the transform coefficient is not the position of the first coefficient, “coeff_parity” may be signaled. That is, for transform coefficients whose positions are not 0, “coeff_parity” may be signaled when the value of “parity hiding” is 0.

In addition, for example, when the value of “parity hiding” is 1, “coeff_parity” may be signaled depending on the position of the transform coefficient. For example, when the value of “parity_hiding” is 1, “coeff_parity” may be signaled for transform coefficients whose positions are not the position of the first coefficient. That is, “coeff_parity” may not be signaled for the first coefficient.

In addition, “coeff_parity” may be signaled as shown in the table below.

TABLE 24

```
...
  ...
  for ( c = eob − 1 [symbol] c >= 0 [symbol] c −− ) {
    pos = scan[ c ]
    ...
    Sigcoeff
    parityHidden = parity_hiding && ( Sigcoeff > 3 ? 1 : 0 )
    if ( !parityHidden || ( c != eob − 1 )) {
      coeff_parity
    }
  ...
  }
... [symbol]
indicates data missing or illegible when filed
```

Referring to Table 24, “Sigcoeff” and “parityHidden” may be derived. For example, “Sigcoeff” may represent the number of non-zero coefficients. A transform block may be divided into regions each including 16 coefficients in a scan order, and the number of non-zero coefficients within the region may be represented as “Sigcoeff”. In addition, “parityHidden” may be a variable derived based on “parity hiding” and “Sigcoeff”. For example, when a value of “parity_hiding” is 1 and “Sigcoeff” is greater than 3, it may be derived as 1. That is, when parity hiding is applied and the number of non-zero coefficients within the region is greater than 3, “parityHidden” may be derived as 1. In addition, when parity hiding is not applied or when the number of non-zero coefficients within the region is less than or equal to 3, “parityHidden” may be derived as 0.

In addition, “coeff_parity” may be signaled based on “parityHidden” and a position of a transform coefficient. For example, when a value of “parityHidden” is 0 or when the position of the transform coefficient is not the position of a last non-zero coefficient, “coeff_parity” may be signaled.

In addition, for example, when the value of “parityHidden” is 1, “coeff_parity” may be signaled for transform coefficients whose positions are not the position of the last non-zero coefficient. That is, “coeff_parity” may not be signaled for the last non-zero coefficient.

In addition, “coeff_parity” may be signaled as shown in the table below.

TABLE 25

```
...
  ...
  for ( c = eob − 1 [symbol] c >= 0 [symbol] c −− ) {
    pos = scan[ c ]
    ...
    Sigcoeff
    parityHidden = parity_hiding && ( Sigcoeff > 3 ? 1 : 0 )
    if ( !parityHidden || ( c != 0 )) {
      coeff_parity
    }
  ...
  }
... [symbol]
indicates data missing or illegible when filed
```

Referring to Table 25, “coeff_parity” may be signaled based on “parityHidden” and a position of a transform coefficient. For example, when a value of “parityHidden” is 0 or when the position of the transform coefficient is not the position of a first coefficient, “coeff_parity” may be signaled.

In addition, for example, when the value of “parityHidden” is 1, “coeff_parity” may be signaled for transform coefficients whose positions are not the position of the first coefficient. That is, “coeff_parity” may not be signaled for the first coefficient.

In addition, “coeff_parity” may be signaled as shown in the table below.

```
TABLE 26
...
  ...
  for ( c = eob − 1 [symbol] c >= 0 [symbol] c −− ) {
    pos = scan[ c ]
    ...
    Sigcoeff
    if (( !parity_hiding || ( Sigcoeff =< 3 ? 1 : 0 ) || ( c != eob − 1 )) {
      coeff_parity
    }
  ...
  }
... [symbol]
indicates data missing or illegible when filed
```

Referring to Table 26, “coeff_parity” may be signaled based on “parity_hiding”, “Sigcoeff”, and a position of a transform coefficient. That is, when parity hiding is applied, the number of non-zero coefficients is greater than 3, and the position of the transform coefficient is the position of a last non-zero coefficient, “coeff_parity” for the corresponding transform coefficient may not be signaled.

In addition, “coeff_parity” may be signaled as shown in the table below.

TABLE 27

```
...
  ...
  for ( c = eob − 1 [symbol] c >= 0 [symbol] c −− ) {
    pos = scan[ c ]
    ...
    Sigcoeff
    if (( !parity_hiding || ( Sigcoeff =< 3 ? 1 : 0 ) || ( c != 0 )) {
      coeff_parity
    }
  ...
  }
... [symbol]
indicates data missing or illegible when filed
```

Referring to Table 27, “coeff_parity” may be signaled based on “parity hiding”, “Sigcoeff”, and a position of a transform coefficient. That is, when parity hiding is applied, the number of non-zero coefficients is greater than 3, and the position of the transform coefficient is the position of a first coefficient, “coeff_parity” for the corresponding transform coefficient may not be signaled.

In addition, “coeff_parity” may be signaled as shown in the table below.

TABLE 28

```
...
  all_zero
  if (all_zero) {
  ...
  } else {
    ...
    for ( c = eob − 1 [symbol] c >= 0 [symbol] c−− ) {
      pos = scan[ c ]
      Sigcoeff
      parityHidden = parity_hiding && ( Sigcoeff > 3 ? 1 : 0 )
      if ( !parityHidden || ( c != eob − 1 )) {
        coeff_parity
      }
      if ( c == ( eob − 1 )) {
        coeff_base_eob
        level = coeff_base_eob + 1
      } else {
        coeff_base
        level = coeff_base
      }
      ...
      Quant[ pos ] = level
    }
  }
... [symbol]
indicates data missing or illegible when filed
```

Referring to Table 28, “coeff_parity” may be signaled, before “coeff_base_eob” is signaled, based on “parity hiding”, “Sigcoeff”, and a position of a transform coefficient. For example, when parity hiding is applied and the number of non-zero coefficients is greater than 3, “coeff_parity” for the last non-zero coefficient may not be signaled, and only “coeff_parity” for the remaining coefficients may be signaled.

In addition, “coeff_parity” may be signaled as shown in the table below.

TABLE 29

```
...
  all_zero
  if (all_zero) {
  ...
  } else {
    ...
    for ( c = eob − 1 [symbol] c >= 0 [symbol] c−− ) {
      pos = scan[ c ]
      Sigcoeff
      parityHidden = parity_hiding && ( Sigcoeff > 3 ? 1 : 0 [symbol]
      if ( !parityHidden || ( c != 0 )) {
        coeff_parity
      }
      if ( c == ( eob − 1 )) {
        coeff_base_eob
        level = coeff_base_eob + 1
      } else {
        coeff_base
        level = coeff_base
      }
      ...
      Quant[ pos ] = level
    }
  }
... [symbol]
indicates data missing or illegible when filed
```

Referring to Table 29, “coeff_parity” may be signaled, before “coeff_base_eob” is signaled, based on “parity_hiding”, “Sigcoeff”, and a position of a transform coefficient. For example, when parity hiding is applied and the number of non-zero coefficients is greater than 3, “coeff_parity” for the first coefficient may not be signaled, and only “coeff_parity” for the remaining coefficients may be signaled.

In addition, “coeff_parity” may be signaled as shown in the table below.

TABLE 30

```
...
  all_zero
  if (all_zero) {
  ...
  } else {
    ...
    for ( c = eob − 1 [symbol] c >= 0 [symbol] c−− ) {
      pos = scan[ c ]
      if ( c == ( eob − 1 )) {
        coeff_base_eob
        level = coeff_base_eob + 1
      } else {
        coeff_base
        level = coeff_base
      }
      Sigcoeff
      parityHidden = parity_hiding && ( Sigcoeff > 3 ? 1 : 0 )
      if ( !parityHidden || ( c != eob − 1 )) {
        coeff_parity
      }
      ...
      Quant[ pos ] = level
    }
  }
... [symbol]
indicates data missing or illegible when filed
```

Referring to Table 30, “coeff_parity” may be signaled, after “coeff_base_eob” is signaled, based on “parity_hiding”, “Sigcoeff”, and a position of a transform coefficient. For example, when parity hiding is applied and the number of non-zero coefficients is greater than 3, “coeff_parity” for the last non-zero coefficient may not be signaled, and only “coeff_parity” for the remaining coefficients may be signaled.

In addition, “coeff_parity” may be signaled as shown in the table below.

TABLE 31

```
...
  all_zero
  if (all_zero) {
  ...
  } else {
    ...
    for ( c = eob − 1 [symbol] c >= 0 [symbol] c−− ) {
      pos = scan[ c ]
      if ( c == ( eob − 1 )) {
        coeff_base_eob
        level = coeff_base_eob + 1
      } else {
        coeff_base
        level = coeff_base
      }
      Sigcoeff
      parityHidden = parity_hiding && ( Sigcoeff > 3 ? 1 : 0 )
      if ( !parityHidden || ( c != 0 )) {
        coeff_parity
      }
      ...
      Quant[ pos ] = level
    }
  }
... [symbol]
indicates data missing or illegible when filed
```

Referring to Table 31, “coeff_parity” may be signaled, before “coeff_base_eob” is signaled, based on “parity_hiding”, “Sigeoeff”, and a position of a transform coefficient. For example, when parity hiding is applied and the number of non-zero coefficients is greater than 3, “coeff_parity” for the first coefficient may not be signaled, and only “coeff_parity” for the remaining coefficients may be signaled.

In the above-described tables, a condition of “Sigeoeff>3” is included; however, the present disclosure is not limited thereto, and the condition may be replaced with “Sigeoeff>n”, where n may be a positive integer. Specifically, whether to signal “coeff_parity” may be determined based on conditions such as “Sigeoeff>4”, “Sigeoeff>5”, and the like.

Meanwhile, parity hiding may be applied to the current block when an identity transform is not applied to the current block. Alternatively, parity hiding may also be applied to the current block even when an identity transform is applied to the current block.

In addition, parity hiding may be applied to the current block when the current block is a luma block or when a lossy transform is applied to the current block. Alternatively, parity hiding may also be applied to the current block even when the current block is not a luma block or when a lossy transform is not applied to the current block.

In addition, a transform block may be divided into 4×4 sub-blocks, and parity hiding may be applied to each of the sub-blocks. That is, as described above, an encoding apparatus may not signal parity information for a specific transform coefficient of the 4×4 sub-block, and a decoding apparatus may derive parity for the specific transform coefficient. For example, the decoding apparatus may derive parity for the specific transform coefficient based on other transform coefficients except for the specific transform coefficient. In this case, the specific transform coefficient may be a first coefficient in a scan order. Alternatively, the specific transform coefficient may be a last non-zero coefficient in the scan order.

For example, the transform block may be divided, based on the scan order, into regions each including 16 transform coefficients. In this case, the region may be a 4×4 sub-block.

As an example, a 4×4 sub-block may be configured based on 16 transform coefficients. In this case, when a difference between positions of a first non-zero coefficient and a last non-zero coefficient in a scan order within the 4×4 sub-block is greater than n, an encoding apparatus may not signal parity information for a specific coefficient. That is, when the difference between the positions of the first non-zero coefficient and the last non-zero coefficient in the scan order is less than or equal to n, parity information for all coefficients may be signaled, whereas when the difference is greater than n, parity information for a specific coefficient may not be signaled.

In this case, the specific coefficient may be a first coefficient or a last coefficient within the 4×4 sub-block. In addition, the specific coefficient may be both the first coefficient and the last coefficient within the 4×4 sub-block. In addition, the specific coefficient may be a first non-zero coefficient or a last non-zero coefficient within the 4×4 sub-block. In addition, the specific coefficient may be both the first non-zero coefficient and the last non-zero coefficient within the 4×4 sub-block. In addition, the specific coefficient may be at least one of non-zero coefficients within the 4×4 sub-block. In addition, the specific coefficient may be a first coefficient or a last non-zero coefficient in the scan order. Here, n may be a positive integer, specifically 1, 2, 3, 4, 5, 6, 7, 8, and the like. In addition, the present disclosure is not limited to the 4×4 sub-block, and parity information for a first coefficient or a last coefficient may not be signaled based on a difference between positions of a first non-zero coefficient and a last non-zero coefficient in a scan order within a transform block.

In addition, based on the number of non-zero coefficients within the 4×4 sub-block, an encoding apparatus may not signal parity information for a specific coefficient. For example, when the number of non-zero coefficients is greater than n, the encoding apparatus may not signal parity information for a specific coefficient. That is, when the number of non-zero coefficients is less than or equal to n, parity information for all coefficients may be signaled, whereas when the number of non-zero coefficients is greater than n, parity information for a specific coefficient may not be signaled.

In this case, the specific coefficient may be a first coefficient or a last coefficient within the 4×4 sub-block. In addition, the specific coefficient may be both the first coefficient and the last coefficient within the 4×4 sub-block. In addition, the specific coefficient may be a first non-zero coefficient or a last non-zero coefficient within the 4×4 sub-block. In addition, the specific coefficient may be both the first non-zero coefficient and the last non-zero coefficient within the 4×4 sub-block. In addition, the specific coefficient may be at least one of non-zero coefficients within the 4×4 sub-block. In addition, the specific coefficient may be a first coefficient or a last non-zero coefficient in the scan order. Here, n may be a positive integer, specifically 1, 2, 3, 4, 5, 6, 7, 8, 9, 10, 11, 12, 13, 14, 15, and the like.

Specifically, when n is 3, if the number of non-zero coefficients is greater than 3, parity information for a specific coefficient may not be signaled, and if the number of non-zero coefficients is less than or equal to 3, parity information for the specific coefficient may be signaled. That is, when the number of non-zero coefficients is less than or equal to 3, parity information for all coefficients may be signaled.

In addition, when n is 4, if the number of non-zero coefficients is greater than 4, parity information for a specific coefficient may not be signaled, and if the number of non-zero coefficients is less than or equal to 4, parity information for the specific coefficient may be signaled. That is, when the number of non-zero coefficients is less than or equal to 4, parity information for all coefficients may be signaled.

In addition, based on a sum of absolute values of non-zero coefficients within the 4×4 sub-block, an encoding apparatus may not signal parity information for a specific coefficient. For example, when the sum of the absolute values of the non-zero coefficients is greater than a threshold value, the encoding apparatus may not signal parity information for a specific coefficient. In this case, the specific coefficient may be a first coefficient or a last coefficient within the 4×4 sub-block. In addition, the specific coefficient may be both the first coefficient and the last coefficient within the 4×4 sub-block. In addition, the specific coefficient may be a first non-zero coefficient or a last non-zero coefficient within the 4×4 sub-block. In addition, the specific coefficient may be both the first non-zero coefficient and the last non-zero coefficient within the 4×4 sub-block. In addition, the specific coefficient may be at least one of non-zero coefficients within the 4×4 sub-block. In addition, the specific coefficient may be a first coefficient or a last non-zero coefficient in the scan order.

In addition, for example, an encoding apparatus may not signal parity information for a specific coefficient when a sum of absolute values of some of the non-zero coefficients is greater than a threshold value. In this case, the specific coefficient may be a first coefficient or a last coefficient within the 4×4 sub-block. In addition, the specific coefficient may be both the first coefficient and the last coefficient within the 4×4 sub-block. In addition, the specific coefficient may be a first non-zero coefficient or a last non-zero coefficient within the 4×4 sub-block. In addition, the specific coefficient may be both the first non-zero coefficient and the last non-zero coefficient within the 4×4 sub-block. In addition, the specific coefficient may include at least one of non-zero coefficients within the 4×4 sub-block. In addition, the specific coefficient may include at least one of remaining non-zero coefficients except for some of the non-zero coefficients used for comparison with the threshold value. In addition, the specific coefficient may be a first coefficient or a last non-zero coefficient in the scan order.

Meanwhile, when parity information for a specific coefficient is not signaled, a decoding apparatus may derive parity for the specific coefficient based on level values of remaining coefficients except for the specific coefficient.

Parity for the specific coefficient may be derived based on the remaining coefficients. Specifically, parity for the specific coefficient may be derived based on a sum of level values of the remaining coefficients. More specifically, when parity information for a first coefficient is not signaled, the decoding apparatus may derive parity for the first non-zero coefficient based on a sum of level values of the remaining coefficients except for the first coefficient.

For example, a parity check may be performed based on a sum of level values of the remaining coefficients except for the first coefficient. In this case, when the sum is even, parity for the first coefficient may be derived as 0, and when the sum is odd, parity for the first coefficient may be derived as 1. Alternatively, when the sum is even, parity for the first coefficient may be derived as 1, and when the sum is odd, parity for the first coefficient may be derived as 0.

Alternatively, when level values of the coefficients are integers less than 0, a parity check for the first coefficient may be performed using absolute values of the level values of the remaining coefficients. For example, the parity check may be performed based on a sum of absolute values of the level values of the remaining coefficients except for the first coefficient. In this case, when the sum of absolute values is even, parity for the first coefficient may be derived as 0, and when the sum is odd, parity for the first coefficient may be derived as 1. Alternatively, when the sum of absolute values is even, parity for the first coefficient may be derived as 1, and when the sum is odd, parity for the first coefficient may be derived as 0.

In addition, parity for a specific coefficient may be derived based on the remaining coefficients. Specifically, parity for the specific coefficient may be derived based on coefficients having low level values and coefficients having middle level values. More specifically, when parity information for a first coefficient is not signaled, a decoding apparatus may derive parity for the first coefficient based on a sum of a level value of a coefficient having a low level and a level value of a coefficient having a middle level.

For example, a parity check may be performed based on a sum of a level value of a coefficient having a low level and a level value of a coefficient having a middle level. In this case, when the sum is even, parity for the first coefficient may be derived as 0, and when the sum is odd, parity for the first coefficient may be derived as 1. Alternatively, when the sum is even, parity for the first coefficient may be derived as 1, and when the sum is odd, parity for the first coefficient may be derived as 0.

In addition, when level values of the coefficients are integers less than 0, parity for a specific coefficient may be derived based on absolute values of the level values of the coefficients. More specifically, when parity information for a first coefficient is not signaled, a decoding apparatus may derive parity for the first coefficient based on a sum of an absolute value of a level value of a coefficient having a low level and an absolute value of a level value of a coefficient having a middle level.

For example, a parity check may be performed based on a sum of an absolute value of a level value of a coefficient having a low level and an absolute value of a level value of a coefficient having a middle level. In this case, when the sum of the absolute values is even, parity for the first coefficient may be derived as 0, and when the sum is odd, parity for the first coefficient may be derived as 1. Alternatively, when the sum of the absolute values is even, parity for the first coefficient may be derived as 1, and when the sum is odd, parity for the first coefficient may be derived as 0.

In this case, the coefficient having a low level value may be one or a plurality of coefficients. In addition, the coefficient having a middle level value may be one or a plurality of coefficients.

For example, when there are a plurality of coefficients having low level values, a level value of one of the plurality of coefficients may be used. For example, when there are a plurality of coefficients having low level values, a level value of a coefficient having the lowest level value among them may be used. Alternatively, when there are a plurality of coefficients having low level values, a level value of a coefficient having a middle level value among them may be used. Alternatively, when there are a plurality of coefficients having low level values, a level value of a coefficient having the highest level value among them may be used.

In addition, when there are a plurality of coefficients having middle level values, a level value of one of the plurality of coefficients may be used. For example, when there are a plurality of coefficients having middle level values, a level value of a coefficient having the lowest level value among them may be used. Alternatively, when there are a plurality of coefficients having middle level values, a level value of a coefficient having a middle level value among them may be used. Alternatively, when there are a plurality of coefficients having middle level values, a level value of a coefficient having the highest level value among them may be used.

In addition, a coefficient having a low level value may refer to a coefficient having a level value lower than a level value of the first coefficient.

For example, when the level value of the first coefficient is a, the level value of the coefficient having the low level value may be less than a. Alternatively, when the level value of the first coefficient is a, the level value of the coefficient having the low level value may be less than or equal to a.

In addition, for example, when the level value of the first coefficient is a, the level value of the coefficient having a low level value may be greater than or equal to (a−l). Here, l may be a positive integer, and l may be 1, 2, 3, 4, and the like.

In addition, a coefficient having a middle level value may refer to a coefficient having a level value within a specific range based on the level value of the first coefficient.

For example, when the level value of the first coefficient is a, the level value of the coefficient having a middle level value may be within a range of greater than or equal to (a−k) and less than or equal to (a+k). Here, k may be a positive integer, and k may be 1, 2, 3, 4, and the like. Alternatively, the level value of the coefficient having a middle level value may be within a range of greater than or equal to a and less than or equal to (a+k). Alternatively, the level value of the coefficient having a middle level value may be within a range of greater than a and less than or equal to (a+k). Alternatively, the level value of the coefficient having a middle level value may be within a range of greater than or equal to (a−k) and less than or equal to a. Alternatively, the level value of the coefficient having a middle level value may be within a range of greater than (a−k) and less than or equal to a.

In addition, for example, the level value of the coefficient having a middle level value may be equal to the level value of the first coefficient.

In addition, parity for a specific coefficient may be derived based on the remaining coefficients. Specifically, parity for the specific coefficient may be derived based on a level value of a coefficient having a high level value and a level value of a coefficient having a middle level value. More specifically, when parity information for a first coefficient is not signaled, a decoding apparatus may derive parity for the first coefficient based on a sum of a level value of a coefficient having a high level and a level value of a coefficient having a middle level.

For example, a parity check may be performed based on a sum of a level value of a coefficient having a high level and a level value of a coefficient having a middle level. In this case, when the sum is even, parity for the first coefficient may be derived as 0, and when the sum is odd, parity for the first coefficient may be derived as 1. Alternatively, when the sum is even, parity for the first coefficient may be derived as 1, and when the sum is odd, parity for the first coefficient may be derived as 0.

In addition, when level values of the coefficients are integers less than 0, parity for a specific coefficient may be derived based on absolute values of the level values of the coefficients. More specifically, when parity information for a first coefficient is not signaled, a decoding apparatus may derive parity for the first coefficient based on a sum of an absolute value of a level value of a coefficient having a high level and an absolute value of a level value of a coefficient having a middle level.

For example, a parity check may be performed based on a sum of an absolute value of a level value of a coefficient having a high level and an absolute value of a level value of a coefficient having a middle level. In this case, when the sum of the absolute values is even, parity for the first coefficient may be derived as 0, and when the sum is odd, parity for the first coefficient may be derived as 1. Alternatively, when the sum of the absolute values is even, parity for the first coefficient may be derived as 1, and when the sum is odd, parity for the first coefficient may be derived as 0.

At this time, a coefficient having a high level value may be one or a plurality, and a coefficient having an intermediate level value may also be one or a plurality.

For example, when a plurality of coefficients having the high level value are present, a level value of one coefficient among the plurality of coefficients may be used. For example, when a plurality of coefficients having the high level value are present, a level value of a coefficient having the lowest level among the plurality of coefficients may be used. Alternatively, when a plurality of coefficients having the high level value are present, a level value of a coefficient having an intermediate level among the plurality of coefficients may be used. Alternatively, when a plurality of coefficients having the high level value are present, a level value of a coefficient having the highest level among the plurality of coefficients may be used.

Further, when a plurality of coefficients having the intermediate level value are present, a level value of one coefficient among the plurality of coefficients may be used. For example, when a plurality of coefficients having the intermediate level value are present, a level value of a coefficient having the lowest level among the plurality of coefficients may be used. Alternatively, when a plurality of coefficients having the intermediate level value are present, a level value of a coefficient having an intermediate level among the plurality of coefficients may be used. Alternatively, when a plurality of coefficients having the intermediate level value are present, a level value of a coefficient having the highest level among the plurality of coefficients may be used.

Further, the coefficient having the high level value may refer to a coefficient having a level value higher than a level value of the first coefficient.

For example, when the level value of the first coefficient is a, the level value of the coefficient having the high level value may be greater than a. Alternatively, when the level value of the first coefficient is a, the level value of the coefficient having the high level value may be equal to or greater than a.

Further, for example, when the level value of the first coefficient is a, the level value of the coefficient having the high level value may be equal to or greater than (a+h), where h denotes a positive integer, and h may be 1, 2, 3, 4, or the like.

Further, the coefficient having the intermediate level value may refer to a coefficient having a level value within a predetermined range based on the level value of the first coefficient.

For example, when the level value of the first coefficient is a, the level value of the coefficient having the intermediate level value may be within a range equal to or greater than (a−k) and equal to or less than (a+k), where k denotes a positive integer, and k may be 1, 2, 3, 4, or the like. Alternatively, the level value of the coefficient having the intermediate level value may be within a range equal to or greater than a and equal to or less than (a+k). Alternatively, the level value of the coefficient having the intermediate level value may be within a range greater than a and equal to or less than (a+k). Alternatively, the level value of the coefficient having the intermediate level value may be within a range equal to or greater than (a−k) and equal to or less than a. Alternatively, the level value of the coefficient having the intermediate level value may be within a range greater than (a−k) and equal to or less than a.

Further, for example, the level value of the coefficient having the intermediate level value may be equal to the level value of the first coefficient.

Further, parity for a specific coefficient may be derived based on remaining coefficients. Specifically, the parity for the specific coefficient may be derived based on a level value of a coefficient having a high level value and a level value of a coefficient having a low level value. Specifically, when parity information for the first coefficient is not signaled, the decoding apparatus may derive the parity for the first coefficient based on a sum of the level value of the coefficient having the high level value and the level value of the coefficient having the low level value.

For example, a parity check may be performed based on a sum of the level value of the coefficient having the high level value and the level value of the coefficient having the low level value. In this case, when the sum is an even number, the parity for the first coefficient may be derived as 0, and when the sum is an odd number, the parity for the first coefficient may be derived as 1. Alternatively, when the sum is an even number, the parity for the first coefficient may be derived as 1, and when the sum is an odd number, the parity for the first coefficient may be derived as 0.

Further, when the level values of the coefficients are integers less than 0, the parity for a specific coefficient may be derived based on absolute values of the level values of the coefficients. Specifically, when parity information for the first coefficient is not signaled, the decoding apparatus may derive the parity for the first coefficient based on a sum of an absolute value of the level value of the coefficient having the high level value and an absolute value of the level value of the coefficient having the low level value.

For example, a parity check may be performed based on a sum of an absolute value of the level value of the coefficient having the high level value and an absolute value of the level value of the coefficient having the low level value. In this case, when the sum of the absolute values is an even number, the parity for the first coefficient may be derived as 0, and when the sum of the absolute values is an odd number, the parity for the first coefficient may be derived as 1. Alternatively, when the sum of the absolute values is an even number, the parity for the first coefficient may be derived as 1, and when the sum of the absolute values is an odd number, the parity for the first coefficient may be derived as 0.

In this case, as described above, the coefficient having the high level value may be one or a plurality, and the coefficient having the low level value may also be one or a plurality. Further, when a plurality of coefficients having the high level value are present or when a plurality of coefficients having the low level value are present, a method of determining a coefficient to be used may be the same as described above.

As described above, when parity information for a specific coefficient is not signaled, the parity for the specific coefficient may be derived by the decoding apparatus. Although the above description has been provided based on a case where the specific coefficient is the first coefficient, the specific coefficient is not limited to the first coefficient, and the specific coefficient may be at least one of a last coefficient in the 4×4 sub-block, a first non-zero coefficient, a last non-zero coefficient, or at least one of non-zero coefficients.

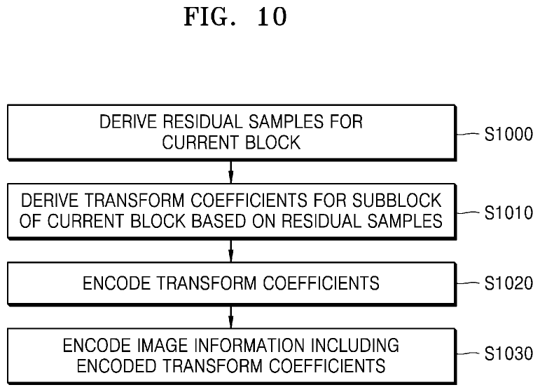

FIG. 10 schematically illustrates a video/image encoding method according to embodiment(s) of the present disclosure. The method disclosed in FIG. 10 may be performed by the encoding apparatus disclosed in FIG. 2. Specifically, for example, operations S1000 to S1010 of FIG. 10 may be performed by a residual processor (230) of the encoding apparatus (200), and operations S1020 to S1030 may be performed by an entropy encoder (240) of the encoding apparatus (200). The method disclosed in FIG. 10 may include the embodiments described above in the present disclosure.

Referring to FIG. 10, the encoding apparatus derives residual samples for a current block (S1000). For example, the encoding apparatus may derive the residual samples for the current block.

For example, the residual samples may be derived based on prediction samples for the current block. Further, residual information for the current block may be generated based on the residual samples.

The encoding apparatus derives transform coefficients for sub-blocks of the current block based on the residual samples (S1010). For example, the encoding apparatus may derive transform coefficients for sub-blocks of the current block based on the residual samples.

The current block may be divided into sub-blocks based on a scan order. In this case, the sub-blocks may be 4×4 sub-blocks.

Whether parity hiding is applied to the current block may be determined. For example, when parity hiding is applied to the current block, the encoding apparatus may not signal parity information for a specific transform coefficient of a sub-block. In this case, the decoding apparatus may derive a parity bit for the specific transform coefficient based on remaining transform coefficients other than the specific transform coefficient. Alternatively, when parity hiding is not applied to the current block, the encoding apparatus may signal parity information for transform coefficients including the specific transform coefficient. That is, parity information for the specific transform coefficient may also be signaled.

For example, whether parity hiding is applied to the current block may be determined based on parity hiding flag information.

Further, for example, when an identity transform is not applied to the current block, the parity hiding may be applied to the current block. Further, for example, when the current block is a luma block to which a lossy transform is applied, the parity hiding may be applied to the current block. For example, when the current block is a luma block and a lossy transform is applied to the current block, the parity hiding may be applied to the current block.

Further, for example, the parity hiding may be applied to the current block based on that non-zero coefficients among transform coefficients for the sub-block are three or more.

Based on that the parity hiding is applied to the current block, a parity bit for a first transform coefficient among the transform coefficients may not be signaled. Alternatively, based on that the parity hiding is not applied to the current block, parity bits for the transform coefficients including the first transform coefficient may be signaled. In this case, the parity bit may correspond to the parity information described above.

For example, when the parity hiding is applied, compensation may be selectively performed for a first transform coefficient to which the parity hiding is applied.

For example, when the parity hiding is applied, since a decoding apparatus may derive the parity bit based on a sum of a level value of a low-level transform coefficient and a level value of a middle-level transform coefficient among transform coefficients for the sub-block, the encoding apparatus may adjust a value of one of the transform coefficients. In this case, the adjustment may be performed by adding +1 to or subtracting −1 from the value of the one of the transform coefficients.

For example, when a sum of level values of the transform coefficients is an even number, the parity bit may be derived as 0 by the decoding apparatus, and thus the encoding apparatus may adjust a value of one of the transform coefficients. Further, when the sum of the level values of the transform coefficients is an odd number, the parity bit may be derived as 1, and thus the encoding apparatus may adjust a value of one of the transform coefficients. In this case, the adjustment may be performed by adding +1 to or subtracting −1 from the value of the one of the transform coefficients.

Further, for example, when the sum of the level values of the transform coefficients is an even number, the parity bit may be derived as 1 by the decoding apparatus, and thus the encoding apparatus may adjust a value of one of the transform coefficients. Further, when the sum of the level values of the transform coefficients is an odd number, the parity bit may be derived as 0, and thus the encoding apparatus may adjust a value of one of the transform coefficients. In this case, the adjustment may be performed by adding +1 to or subtracting −1 from the value of the one of the transform coefficients.

Further, for example, when the level values of the transform coefficients are integers less than 0, parity for a specific coefficient may be derived based on absolute values of the level values of the transform coefficients. For example, when the parity hiding is applied, since the decoding apparatus may derive the parity bit based on a sum of an absolute value of a level value of a low-level transform coefficient and an absolute value of a level value of a middle-level transform coefficient among transform coefficients for the sub-block, the encoding apparatus may adjust a value of one of the transform coefficients. In this case, the adjustment may be performed by adding +1 to or subtracting −1 from the value of the one of the transform coefficients.

For example, when a sum of absolute values of level values of the transform coefficients is an even number, the parity bit may be derived as 0 by the decoding apparatus, and thus the encoding apparatus may adjust a value of one of the transform coefficients. Further, when the sum of the absolute values of the level values of the transform coefficients is an odd number, the parity bit may be derived as 1, and thus the encoding apparatus may adjust a value of one of the transform coefficients. In this case, the adjustment may be performed by adding +1 to or subtracting −1 from the value of the one of the transform coefficients.

Further, for example, when the sum of the absolute values of the level values of the transform coefficients is an even number, the parity bit may be derived as 1, and thus the encoding apparatus may adjust a value of one of the transform coefficients. Further, when the sum of the absolute values of the level values of the transform coefficients is an odd number, the parity bit may be derived as 0, and thus the encoding apparatus may adjust a value of one of the transform coefficients. In this case, the adjustment may be performed by adding +1 to or subtracting −1 from the value of the one of the transform coefficients.

When the parity hiding is applied, a parity bit for a specific transform coefficient may not be signaled. In this case, the specific transform coefficient is not limited to the first transform coefficient, and the specific transform coefficient may be at least one of a last transform coefficient in a 4×4 sub-block, a first non-zero transform coefficient, a last non-zero transform coefficient, or one of non-zero transform coefficients.

For example, parity for the specific transform coefficient may not be signaled and may be derived by the decoding apparatus based on a sum of remaining transform coefficients except for the specific transform coefficient, and thus the encoding apparatus may adjust a value of one of the transform coefficients. In this case, the adjustment may be performed by adding +1 to or subtracting −1 from the value of the one of the transform coefficients. However, the adjustment is not limited thereto, and the adjustment may be performed by adding “a” to a value of one of the transform coefficients, where “a” has an integer value and may be −1, −2, −3, or +1, +2, +3, or the like. Further, the adjustment may be performed based on values of one or more transform coefficients. For example, among two or more transform coefficients, a value of one transform coefficient may be adjusted by adding “b”, and a value of another transform coefficient may be adjusted by adding “c”, where “b” and “c” have integer values. Further, the adjustment may be performed for three or more transform coefficients.

For example, since the decoding apparatus may derive parity for the specific transform coefficient based on a low-level transform coefficient and a middle-level transform coefficient, the encoding apparatus may adjust a value of one of the transform coefficients. Specifically, the decoding apparatus may derive parity for the specific transform coefficient based on a sum of a level value of the low-level transform coefficient and a level value of the middle-level transform coefficient. Alternatively, when the level values of the transform coefficients are negative integers, parity for the specific coefficient may be derived based on absolute values of the level values of the coefficients. In this case, the decoding apparatus may derive parity for the specific transform coefficient based on a sum of an absolute value of the level value of the low-level transform coefficient and an absolute value of the level value of the middle-level transform coefficient. For this case, the encoding apparatus may adjust a value of one of the transform coefficients.

Further, for example, since the decoding apparatus may derive parity for the specific transform coefficient based on a high-level transform coefficient and a middle-level transform coefficient, the encoding apparatus may adjust a value of one of the transform coefficients. Specifically, the decoding apparatus may derive parity for the specific transform coefficient based on a sum of a level value of the high-level transform coefficient and a level value of the middle-level transform coefficient. Alternatively, when the level values of the transform coefficients are negative integers, parity for the specific coefficient may be derived based on absolute values of the level values of the coefficients. In this case, the decoding apparatus may derive parity for the specific transform coefficient based on a sum of an absolute value of a level value of the high-level transform coefficient and an absolute value of a level value of the middle-level transform coefficient. For this case, the encoding apparatus may adjust a value of one of the transform coefficients.

Further, for example, since the decoding apparatus may derive parity for the specific transform coefficient based on a high-level transform coefficient and a low-level transform coefficient, the encoding apparatus may adjust a value of one of the transform coefficients. Specifically, the decoding apparatus may derive parity for the specific transform coefficient based on a sum of a level value of the high-level transform coefficient and a level value of the low-level transform coefficient. Alternatively, when the level values of the transform coefficients are negative integers, parity for the specific coefficient may be derived based on absolute values of the level values of the coefficients. In this case, the decoding apparatus may derive parity for the specific transform coefficient based on a sum of an absolute value of a level value of the high-level transform coefficient and an absolute value of a level value of the low-level transform coefficient. For this case, the encoding apparatus may adjust a value of one of the transform coefficients.

The encoding apparatus encodes the transform coefficients (S1020). For example, the encoding apparatus may encode the transform coefficients.

The transform coefficients may be encoded based on whether parity hiding is applied to the current block.

For example, based on that the parity hiding is applied to the current block, transform coefficients having a number equal to a number of transform coefficients for the sub-block minus one may be encoded. Further, based on that the parity hiding is not applied to the current block, transform coefficients having a number equal to a number of transform coefficients for the sub-block may be encoded.

The encoding apparatus encodes image information including the encoded transform coefficients (S1030). For example, the encoding apparatus may encode the image information including the transform coefficients.

For example, the image information may include information represented by syntax elements as residual information signaled for deriving the transform coefficients described above. For example, the syntax elements may indicate at least one of information included in Tables 1 to 3 and Tables 8 to 25 described above.

The image information may further include prediction-related information, transform information, and residual information as described above. Further, the image information may include parity hiding flag information indicating whether parity hiding is applied to the current block. Further, the image information may include information related to transform coefficients for the sub-block. In this case, the parity hiding flag information may be signaled prior to information related to the transform coefficients for the sub-block. Further, the parity hiding flag information may be included in sequence syntax, frame syntax, or tile syntax and may be signaled. Further, the image information may include the information described above in the present disclosure.

According to the embodiment(s) described above, by not signaling parity information for a specific transform coefficient, an amount of information to be signaled may be reduced, thereby enabling efficient coding. Further, by adjusting remaining transform coefficients to selectively derive a parity bit of the transform coefficient, coding efficiency may be improved and image compression performance may be enhanced.

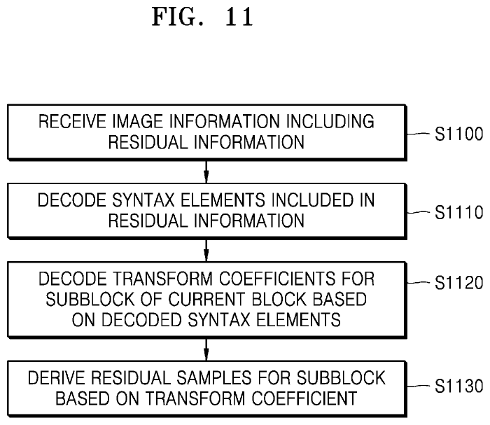

FIG. 11 schematically illustrates a video/image decoding method according to embodiment(s) of the present disclosure. The method disclosed in FIG. 11 may be performed by the decoding apparatus disclosed in FIG. 3. Specifically, for example, operations S1100 to S1120 of FIG. 11 may be performed by an entropy decoder (310) of the decoding apparatus (300), and operation S1130 may be performed by a residual processor (320) of the decoding apparatus (300). The method disclosed in FIG. 11 may include the embodiments described above in the present disclosure.

Referring to FIG. 11, the decoding apparatus receives image information including residual information for a current block (S1100). For example, the decoding apparatus may receive the image information including the residual information through a bitstream. The image information may further include prediction-related information, transform information, and residual information as described above. Further, the image information may include parity hiding flag information indicating whether parity hiding is applied to the current block. Further, the image information may include information related to transform coefficients for a sub-block. In this case, the parity hiding flag information may be signaled prior to information related to the transform coefficients for the sub-block. Further, the parity hiding flag information may be included in sequence syntax, frame syntax, or tile syntax and may be signaled. Further, the image information may include the information described above in the present disclosure.

The decoding apparatus decodes syntax elements included in the residual information (S1110). For example, the decoding apparatus may decode the syntax elements included in the residual information.

The syntax elements may be residual information signaled for deriving the transform coefficients described above. For example, the syntax elements may indicate at least one of information included in Tables 1 to 3 and Tables 8 to 25 described above.

The decoding apparatus decodes transform coefficients for sub-blocks of the current block based on the decoded syntax elements (S1120). For example, the decoding apparatus may decode transform coefficients for sub-blocks of the current block based on the decoded syntax elements.

The current block may be divided into sub-blocks based on a scan order. In this case, the sub-blocks may be 4×4 sub-blocks.

Whether parity hiding is applied to the current block may be determined. For example, when parity hiding is applied to the current block, parity information for a specific transform coefficient of a sub-block may not be signaled. In this case, the decoding apparatus may derive a parity bit for the specific transform coefficient based on remaining transform coefficients other than the specific transform coefficient. Alternatively, when parity hiding is not applied to the current block, parity information for transform coefficients including the specific transform coefficient may be signaled. That is, parity information for the specific transform coefficient may also be signaled, and a parity bit for the specific transform coefficient may be derived based on the parity information.

For example, whether parity hiding is applied to the current block may be determined based on the parity hiding flag information.

Further, for example, when an identity transform is not applied to the current block, the parity hiding may be applied to the current block. Further, for example, when the current block is a luma block to which a lossy transform is applied, the parity hiding may be applied to the current block. For example, when the current block is a luma block and a lossy transform is applied to the current block, the parity hiding may be applied to the current block.

Further, for example, the parity hiding may be applied to the current block based on that non-zero coefficients among transform coefficients for the sub-block are three or more.

Based on that the parity hiding is applied to the current block, a parity bit for a first transform coefficient among the transform coefficients may be derived.

For example, when the parity hiding is applied, the parity bit may be derived based on a sum of a level value of a low-level transform coefficient and a level value of a middle-level transform coefficient among transform coefficients for the sub-block. For example, the low-level transform coefficient may refer to a coefficient having a low level value described above, and the middle-level transform coefficient may refer to a coefficient having a middle level value described above. Accordingly, the sum of the level value of the low-level transform coefficient and the level value of the middle-level transform coefficient may refer to a sum of the coefficient having the low level value and the coefficient having the middle level value.

Based on that the parity hiding is applied to the current block, transform coefficients having a number equal to a number of transform coefficients for the sub-block minus one may be decoded. Further, based on that the parity hiding is not applied to the current block, transform coefficients having a number equal to a number of transform coefficients for the sub-block may be decoded.

Based on the decoded transform coefficients, a parity bit for a first transform coefficient may be derived. For example, when a sum of level values of the decoded transform coefficients is an even number, the parity bit may be derived as 0, and when the sum of the level values of the decoded transform coefficients is an odd number, the parity bit may be derived as 1.

Further, for example, when a sum of level values of the decoded transform coefficients is an even number, the parity bit may be derived as 1, and when the sum of the level values of the decoded transform coefficients is an odd number, the parity bit may be derived as 0.

Further, for example, when the level values of the decoded transform coefficients are integers less than 0, when a sum of absolute values of the level values of the decoded transform coefficients is an even number, the parity bit may be derived as 0, and when the sum of the absolute values of the level values of the decoded transform coefficients is an odd number, the parity bit may be derived as 1.

Further, for example, when a sum of absolute values of level values of the decoded transform coefficients is an even number, the parity bit may be derived as 1, and when the sum of the absolute values of the level values of the decoded transform coefficients is an odd number, the parity bit may be derived as 0.

When the parity hiding is applied, a parity bit for a specific transform coefficient may be derived based on the decoded transform coefficients. In this case, the specific transform coefficient is not limited to the first transform coefficient, and the specific transform coefficient may be at least one of a last transform coefficient in a 4×4 sub-block, a first non-zero transform coefficient, a last non-zero transform coefficient, or one of non-zero transform coefficients.

For example, parity for the specific transform coefficient may be derived based on a sum of remaining transform coefficients except for the specific transform coefficient.

For example, parity for the specific transform coefficient may be derived based on a low-level transform coefficient and a middle-level transform coefficient. Specifically, the parity for the specific transform coefficient may be derived based on a sum of a level value of the low-level transform coefficient and a level value of the middle-level transform coefficient. Alternatively, when the level values of the transform coefficients are negative integers, the decoding apparatus may derive parity for the specific transform coefficient based on a sum of a level value of the low-level transform coefficient and an absolute value of a level value of the middle-level transform coefficient.

Further, for example, parity for the specific transform coefficient may be derived based on a high-level transform coefficient and a middle-level transform coefficient. Specifically, the parity for the specific transform coefficient may be derived based on a sum of a level value of the high-level transform coefficient and a level value of the middle-level transform coefficient. Alternatively, when the level values of the transform coefficients are negative integers, the parity for the specific transform coefficient may be derived based on a sum of a level value of the high-level transform coefficient and an absolute value of a level value of the middle-level transform coefficient.

Further, for example, parity for the specific transform coefficient may be derived based on a high-level transform coefficient and a low-level transform coefficient. Specifically, the parity for the specific transform coefficient may be derived based on a sum of a level value of the high-level transform coefficient and a level value of the low-level transform coefficient. Alternatively, when the level values of the transform coefficients are negative integers, the parity for the specific transform coefficient may be derived based on a sum of a level value of the high-level transform coefficient and an absolute value of a level value of the low-level transform coefficient.

Further, for example, a method of determining the low-level transform coefficient, the middle-level transform coefficient, and the high-level transform coefficient used for deriving parity for the specific transform coefficient may be the method described above.

The decoding apparatus derives residual samples for the sub-block based on the transform coefficients (S1130). For example, the decoding apparatus may derive the residual samples for the sub-block based on the transform coefficients.

According to the embodiment(s) described above, by hiding parity information for a specific transform coefficient, an amount of information to be signaled may be reduced, thereby enabling efficient coding. Further, by selectively deriving a parity bit of a transform coefficient, coding efficiency may be improved and image compression performance may be enhanced.

Although the methods are described based on a flowchart as a series of steps or blocks in the aforementioned embodiments, the embodiments are not limited to the order of the steps, and a certain step may occur in a different order or concurrently with another step described above. Furthermore, it will be understood by those skilled in the art that the steps shown in the flowchart are not exclusive, and that other steps may be included or one or more steps in the flowchart may be deleted without affecting the scope of the embodiments of the disclosure

The aforementioned methods according to the embodiments of the disclosure may be implemented in software form, and the encoding apparatus and/or the decoding apparatus according to the disclosure may be included in a device for performing image processing, for example, a TV, a computer, a smartphone, a set-top box, and a display device.

The aforementioned embodiments of the disclosure may be implemented in the form of a recording medium including a computer-executable (program) instruction, such as a program module executed by a computer. The module may be stored in a memory and executed by a processor. The memory may reside inside or outside the processor, and may be connected to the processor by various well-known means. A computer-readable medium may be any available medium accessible by a computer, and may include both volatile and nonvolatile media and removable and non-removable media. Furthermore, the computer-readable medium may include both a computer storage medium and a communication medium. The computer storage medium may include both volatile and nonvolatile media and removable and non-removable media implemented in any method or technology for storing information, such as a computer-readable instruction, a data structure, a program module, or other data. The communication medium typically includes a computer-readable instruction, a data structure, a program module, other data in a modulated data signal such as a carrier wave, or other transfer mechanisms, and includes any information delivery medium.

Furthermore, the embodiments of the disclosure described above may be implemented as a computer program (or computer program product) including a computer-executable instruction. The computer program may include a programmable machine instruction processed by a processor, and may be implemented in a high-level programming language, an object-oriented programming language, an assembly language, or a machine language. In addition, the computer program may be recorded in a tangible computer-readable recording medium (e.g., a memory, a hard disk, a magnetic/optical medium, or a solid-state drive (SSD).

Therefore, the embodiments of the disclosure may be implemented as the aforementioned computer program is executed by a computing device. The computing device may include at least some of a processor, a memory, a storage device, a high-speed interface connected to the memory and a high-speed expansion port, and a low-speed interface connected to a low-speed bus and the storage device. These components may be interconnected via various buses, and may be mounted on a common motherboard or in other suitable manners.

The processor may process an instruction within the computing device. The instruction may include an instruction stored in the memory or the storage device to display graphical information for providing a graphical user interface (GUI) on an external input/output device, such as a display connected to the high-speed interface. In another embodiment, a plurality of processors and/or a plurality of buses may be utilized appropriately along with a plurality of memories and memory types. Further, the processor may be implemented as a chipset of chips including a plurality of independent analog and (or) digital processors.

The memory stores information within the computing device. For example, the memory may include a volatile memory unit or a set of volatile memory units. In another example, the memory may include a nonvolatile memory unit or a set of nonvolatile memory units. The memory may also be another form of computer-readable medium, such as a magnetic or optical disk.

The storage device may provide a high-capacity storage space for the computing device. The storage device may be a computer-readable medium or a component including a computer-readable medium. For example, the storage device may include devices or other components within a storage area network (SAN), and may be a floppy disk device, a hard disk device, an optical disk device, a tape device, a flash memory, other similar semiconductor memory devices, or an array of devices.

The network may be implemented as a wired network, such as a local area network (LAN), a wide area network (WAN), or a value-added network (VAN), or various types of wireless networks, such as a mobile radio communication network or a satellite communication network.

Although the disclosure has been described with reference to the embodiments illustrated in the drawings, these embodiments are merely exemplary. It will be understood by those skilled in the art that various modifications and variations of the embodiments are possible. That is, the scope of the disclosure is not limited to the above-described embodiments, and various modifications and alterations made by those skilled in the art based on the basic concepts defined in the following claims also fall within the scope of the claims. Therefore, the true technical protection scope of the disclosure should be determined by the technical spirit of the appended claims.

What is claimed is:

1. An image decoding method performed by a decoding apparatus, the method comprising:
receiving image information including residual information for a current block;
decoding syntax elements included in the residual information;
decoding transform coefficients for the current block based on the decoded syntax elements; and
deriving residual samples for the current block based on the transform coefficients,
wherein whether parity hiding is applied to the current block is determined, and
wherein the transform coefficients are derived based on parity for a specific transform coefficient based on that the parity hiding is applied to the current block.

2. The method of claim 1,
wherein the current block is divided into sub-blocks based on a scan order, and
wherein the sub-block is a 4×4 sub-block.

3. The method of claim 1,
wherein the image information includes parity hiding flag information, and
wherein the parity hiding flag information indicates whether the parity hiding is applied to the current block.

4. The method of claim 1,
wherein the parity hiding flag information is signaled prior to information related to the transform coefficients for the current block.

5. The method of claim 3,
wherein the parity hiding flag information is included in a sequence header, a tile header, or a frame header and is signaled.

6. The method of claim 1,
wherein the parity hiding is applied to the current block based on that an identity transform is not applied to the current block.

7. The method of claim 1,
wherein the current block is a luma block, and
wherein the parity hiding is applied to the current block based on that a lossy transform is applied to the current block.

8. The method of claim 1,
wherein the parity hiding is applied to the current block based on that non-zero coefficients among the transform coefficients for the current block are four or more.

9. The method of claim 1,
wherein a parity bit is derived based on a sum of a level value of a low-level transform coefficient and a level value of a middle-level transform coefficient among the transform coefficients for the current block.

10. The method of claim 1,
wherein transform coefficients having a number equal to a number of transform coefficients for the current block minus one are decoded based on that the parity hiding is applied to the current block.

11. The method of claim 1,
wherein transform coefficients having a number equal to a number of transform coefficients for the current block are decoded based on that the parity hiding is not applied to the current block.

12. The method of claim 10,
wherein the parity bit is derived based on level values of the decoded transform coefficients.

13. The method of claim 10,
wherein the parity bit is derived as 0 based on that a sum of level values of the decoded transform coefficients is even, and
wherein the parity bit is derived as 1 based on that the sum of the level values of the decoded transform coefficients is odd.

14. An image encoding method performed by an encoding apparatus, the method comprising:
deriving residual samples for a current block;
deriving transform coefficients for the current block based on the residual samples;
encoding the transform coefficients; and
encoding image information including the encoded transform coefficients,
wherein whether parity hiding is applied to the current block is determined, and
wherein parity-related information for a specific transform coefficient is not signaled based on that the parity hiding is applied to the current block.

15. The method of claim 14,
wherein the image information includes parity hiding flag information,
wherein the parity hiding flag information indicates whether the parity hiding is applied to the current block.

16. The method of claim 14,
wherein the parity hiding is applied to the current block based on that non-zero coefficients among the transform coefficients for the current block are four or more.

17. The method of claim 14,
wherein the parity hiding flag information is signaled prior to information related to the transform coefficients for the current block.

18. The method of claim 14,
wherein transform coefficients having a number equal to a number of transform coefficients for the current block minus one are encoded based on that the parity hiding is applied to the current block.

19. The method of claim 14,
wherein transform coefficients having a number equal to a number of transform coefficients for the current block are encoded based on that the parity hiding is not applied to the current block.

20. A transmitting method for image data, the method comprising:
obtaining a bitstream generated by an image encoding method, wherein the bitstream is generated based on deriving residual samples for a current block, deriving transform coefficients for the current block based on the residual samples, encoding the transform coefficients, and encoding image information including the encoded transform coefficients; and
transmitting the image data including the bitstream,
wherein whether parity hiding is applied to the current block is determined, and
wherein parity-related information for a specific transform coefficient is not signaled based on that the parity hiding is applied to the current block.
